(19) United States
(12) Patent Application Publication
(10) Pub. No.: US 2022/0044423 A1
(43) Pub. Date: Feb. 10, 2022

(54) BALL TRAJECTORY TRACKING

(71) Applicant: PLAYSIGHT INTERACTIVE LTD., Kfar Saba (IL)

(72) Inventors: Evgeny TSIZIN-GOLDMAN, Ramat-Gan (IL); Evgeni KHAZANOV, Petah Tiqva (IL); Israel OR, Rosh HaAyin (IL); Chen SHACHAR, Kohav Yair (IL)

(73) Assignee: PLAYSIGHT INTERACTIVE LTD., Kfar Saba (IL)

(21) Appl. No.: 17/298,480

(22) PCT Filed: Mar. 14, 2019
(86) PCT No.: PCT/IB2019/052081

§ 371 Date: May 28, 2021

(30) Foreign Application Priority Data
Dec. 2, 2018 (IB) PCT/IB2018/059549

(51) Int. Cl. G06T 7/254; G06K 9/00

(52) U.S. Cl. CPC G06T 7/254; G06K 9/00724; G06K 9/00979; G06T 2207/20224; G06T 2207/20016; G06T 2207/30224; G06T 2207/30241; G06K 2009/00738; G06T 2207/20084

(57) ABSTRACT

A method of ball trajectory tracking, the method comprising computer executable steps of: receiving a plurality of training frames, each one of the training frames showing a trajectory of a ball as a series of one or more elements, using the received training frames, training a first neuronal network to locate a trajectory of a ball in a frame, receiving a second frame, and using the first neuronal network, locating a trajectory of a ball in the second frame, the trajectory being shown in the second frame as a series of images of the ball having the located trajectory.

### FIELD AND BACKGROUND OF THE INVENTION

The present invention relates to video image processing during a sport event such as a tennis match or a training session, a soccer game or a training session, a football match, etc., and more particularly, but not exclusively to a system and method of ball trajectory tracking.

Such video image processing with which a ball is tracked, say during a sport event is often used for following certain events that occur during the sport event, which events need to be detected and classified. Many of the events are detected based on the ball's motion and position. The events detected during a sport event may include, for example, a ball's hitting the ground—i.e. an “In” or an “Out” event (say in tennis), a ball's entering a basket (in basketball) or a soccer gate, a ball's passing from one player to another, etc.

A video of a sport event may be divided into a quasi-static background (such as the court lines) and a dynamic foreground (usually, the moving players and ball).

Naturally, it is the foreground which bears information that reveals the dynamics of the sport event (say game) and therefore, the video image processing may focus on that background.

However, even when limiting most of the video processing to that foreground, ball detection and classification methods needed for tracking the ball's movement, so as to identify or classify such events, may prove to be non-trivial.

For example, when captured in video, many objects other than a ball may nevertheless resemble a ball. Due to the finite exposure time of camera shutter mechanisms, a ball (as captured in video) may appear somewhat elongated, and the ball's image may be distorted while propagating through the camera optics to the camera sensors. While captured from great distance, an image of a ball as captured in a sequence of video images may appear as a small aggregate of pixels which hardly resemble a ball.

For these and other reasons, especially when resources (such as processing power, processing time, data storage, etc.) are limited, many objects other than the ball (say a player's head or foot, a symbol printed on a player's shirt, etc.) as captured in video during a sport event, may be mistakenly identified as the ball.

Recently, Deep Learning methods, in general, and neural networks, in particular, have been employed to solve image processing problems of the sort discussed hereinabove. Tunable parameters of such neuronal networks are usually based on the learning of large databases of usually, labeled objects of interest.

The most computationally intensive part of deep learning using neuronal networks is usually carried out in a preliminary offline stage in which large databases of training data are used, which stage is often performed by GPUs (Graphical Processing Units). In that preliminary stage, the objective is to tune the neuronal network's parameters in such a way that a system used to process video images to captured during a sport event itself (i.e. on-line) can identify the ball in different realistic circumstances.

However, the online stage of applying a neural network created during the offline stage too may be computationally intensive, as it may have to be performed in real time (say 25-50 times a second). Thus, this stage too may substantially add to the resources needed for carrying out such image processing processes based on deep learning.

### SUMMARY OF THE INVENTION

According to one aspect of the present invention, there is provided a method of ball trajectory tracking, the method comprising computer executable steps of receiving a plurality of training frames, each one of the training frames showing a trajectory of a ball as a series of one or more elements, using the received training frames, training a first neuronal network to locate a trajectory of a ball in a frame, receiving a second frame, and using the first neuronal network, locating a trajectory of a ball in the second frame, the trajectory being shown in the second frame as a series of images of the ball having the located trajectory.

Optionally, the method of further comprises receiving labeling data for each respective one of the received training frames, the labeling data indicating a location of the trajectory within the training frame.

Optionally, the method further comprises using a second neuronal network to recognize an image of a ball along the trajectory located using the first neuronal network.

Optionally, the method further comprises using the first neuronal network to recognize an image of a ball along the trajectory located using the first neuronal network.

Optionally, the method further comprises determining occurrence of a predefined event during a sport event, using the trajectory located in the second frame.

Optionally, the method further comprises computer-executed steps of receiving a video sequence capturing movement of a ball during a sport event in a series of video frames, calculating a plurality of difference-frames, each difference-frame being calculated over a respective group of at least two of the video frames of the received video sequence, and combining at least two of the calculated difference-frames, to form a composite frame representing a trajectory taken by the ball in the movement as a series of images of the ball as captured in the received video sequence, the composite frame being one of the group consisting of the training frames and the second frame.

According to a second aspect of the present invention, there is provided a non-transitory computer readable medium storing computer executable instructions for performing steps of ball trajectory tracking, the steps comprising: receiving a plurality of training frames, each one of the training frames showing a trajectory of a ball as a series of one or more elements, using the received training frames, training a first neuronal network to locate a trajectory of a ball in a frame, receiving a second frame, and using the first neuronal network, locating a trajectory of a ball in the second frame, the trajectory being shown in the second frame as a series of images of the ball having the located trajectory.

Optionally, the computer readable medium further stores computer executable instructions for performing a step of receiving labeling data for each respective one of the received training frames, the labeling data indicating a location of the trajectory within the training frame.

Optionally, the computer readable medium further stores computer executable instructions for performing steps of: receiving a video sequence capturing movement of a ball during a sport event in a series of video frames, calculating a plurality of difference-frames, each difference-frame being calculated over a respective group of at least two of the video frames of the received video sequence, and combining at least two of the calculated difference-frames, to form a composite frame representing a trajectory taken by the ball in the movement as a series of images of the ball as captured in the received video sequence, the composite frame being one of the group consisting of the training frames and the second frame.

Optionally, the computer readable medium further stores computer executable instructions for performing a step of using a second neuronal network to recognize an image of a ball along the trajectory located using the first neuronal network.

Optionally, the computer readable medium further stores computer executable instructions for performing a step of using the first neuronal network to recognize an image of a ball along the trajectory located using the first neuronal network.

Optionally, the computer readable medium further stores computer executable instructions for performing a step of determining occurrence of a predefined event during a sport event, using the trajectory located in the second frame.

According to a second third of the present invention, there is provided an apparatus for ball trajectory tracking, the apparatus comprising computing circuitry, and a computer memory storing instructions that when executed by the computing circuitry, configure the computing circuitry to perform steps of: receiving a plurality of training frames, each one of the training frames showing a trajectory of a ball as a series of one or more elements, using the received training frames, training a first neuronal network to locate a trajectory of a ball in a frame, receiving a second frame, and using the first neuronal network, locating a trajectory of a ball in the second frame, the trajectory being shown in the second frame as a series of images of the ball having the located trajectory.

Optionally, the computer memory further stores instructions for performing steps of: receiving a video sequence capturing movement of a ball during a sport event in a series of video frames, calculating a plurality of difference-frames, each difference-frame being calculated over a respective group of at least two of the video frames of the received video sequence, and combining at least two of the calculated difference-frames, to form a composite frame representing a trajectory taken by the ball in the movement as a series of images of the ball as captured in the received video sequence, the composite frame being one of the group consisting of the training frames and the second frame.

Optionally, the computer memory further stores instructions for performing computer executable instructions for performing a step of using a second neuronal network to recognize an image of a ball along the trajectory located using the first neuronal network.

Optionally, the computer memory further stores instructions for performing computer executable instructions for performing a step of using the first neuronal network to recognize an image of a ball along the trajectory located using the first neuronal network.

Optionally, the computer memory further stores instructions for performing a step of determining occurrence of a predefined event during a sport event, using the trajectory located in the second frame.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings.

With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 is a simplified flowchart schematically illustrating a first exemplary method of ball trajectory tracking, according to an exemplary embodiment of the present invention.

FIG. 2 is a simplified flowchart schematically illustrating a second exemplary method of ball trajectory tracking, according to an exemplary embodiment of the present invention.

FIG. 3-11 are simplified block diagrams schematically illustrating an exemplary implementation scenario of ball trajectory tracking, according to an exemplary embodiment of the present invention.

FIG. 12 is a simplified block diagram schematically illustrating a first exemplary non-transitory computer readable medium storing computer executable instructions for performing steps of ball trajectory tracking, according to an exemplary embodiment of the present invention.

FIG. 13 is a simplified block diagram schematically illustrating a second exemplary non-transitory computer readable medium storing computer executable instructions for performing steps of ball trajectory tracking, according to an exemplary embodiment of the present invention.

FIG. 14 is a simplified block diagram schematically illustrating an exemplary apparatus for ball trajectory tracking, according to an exemplary embodiment of the present invention.

### DESCRIPTION OF THE PREFERRED EMBODIMENTS

The present embodiments comprise an apparatus, a method, and a computer readable medium for ball trajectory tracking.

With the exemplary embodiments of the present invention, there is received a plurality of training frames. Each one of the received training frames shows a trajectory of a ball as a series of one or more elements.

The received training frames may include, for example, one or more composite frames generated in the manner described in further detail hereinbelow.

Additionally or alternatively, the received training frames may include one or more frames in which a trajectory of a ball (say a ball hit by a player during a tennis match) is represented using one or more elements. The elements may include, for example, parts of a dashed line, dots of a dotted line, a solid line, images of a ball, oval graphical objects, graphic symbols, etc., or any combination thereof, as described in further detail hereinbelow.

Then, the received frames are used to train a neuronal network to locate a trajectory of a ball in a frame, say using labeling data received with each respective one of the training frames.

The labeling data may include, for example, one or more graphical elements such as a rectangle added to the frame, say using a graphical editor, as known in the art, so as to mark an area of the frame surrounding the trajectory as shown in the frame, a mark added to each image of a ball that represents a position along the ball's trajectory, etc., as described in further detail hereinbelow.

Later, there is received a second frame, say a one captured during a game of sport (say a tennis match or a soccer game), say a composite frame generated from a video stream captured during the game of sport, as described in further detail hereinbelow. The second frame shows a trajectory of a ball as a series of images of the ball having the located trajectory, as described in further detail hereinbelow.

Then, the neuronal network is used to locate the trajectory of the ball in the second frame, and optionally, to identify an event based on the located trajectory, as described in further detail hereinbelow.

Optionally, the training frames, the second frame, or both, are composite frames generated from a video sequence captured by a camera during the sport event, as described in further detail hereinbelow.

Thus, with some exemplary embodiments of the present invention, a video sequence captured by a camera during a sport event, is used for tracking a trajectory taken by a ball during the sport event.

The sport event may include, but is not limited to a sport event such as a tennis match or a tennis training session, a soccer game or a soccer training session, a football match or a football training session, etc., as described in further detail hereinbelow.

Accordingly to some exemplary embodiments of the present invention, during a sport event that takes place in a constrained environment such as a tennis court or a football field, there is received a video sequence that captures movement of a ball during the sport event in a series of video frames.

In one example, the video sequence is captured using a video camera installed in the constrained environment and is streamed live from the video camera to a system that implements one or more of the methods of the present invention, say to an apparatus implemented on a remote computer in communication with the video camera, as described in further detail hereinbelow.

Then, based on the received video sequence, there is calculated a plurality of difference-frames. Each one of the difference-frames is calculated over a respective group of two or more of the video frames of the received video sequence.

The difference-frame may be calculated, for example, by subtracting between pixel values of the two or more video frames that make up that group of video frames, by calculating a high order difference over the video frames of the group (say a difference between differences), by applying a predefined formula on pixel values of the video frames of the group, etc., as described in further detail hereinbelow.

Thus, each one of the difference-frames is a video frame that represents a difference among the two or more video frames of the respective group. The difference-frame is accordingly likely to include an image of one or more moving objects, as captured in different positions, in the video frames that make up the received video sequence.

The difference-frame is thus meant to include two or more images of the ball, such that each image of the ball as appearing in the difference-frame, has a different position within the frame and represents a different position of the moving ball, but omits at least some of the video sequence's background elements (say court lines or fences), or a part thereof.

Then, at least two of the calculated difference-frames are combined so as to form a composite frame that represents a trajectory taken by the ball in the movement as a series of images of the ball as captured in the received video sequence, as described in further detail hereinbelow. As a result, the composite frame represents positions of the ball as represented in two or more difference-frames, as described in further detail hereinbelow.

Each image of the ball that appears in the composite frame has a different position within the composite frame and represents a different position of the moving ball along the trajectory, as described in further detail hereinbelow.

Optionally, the composite frame is further added one or more background elements omitted from the difference-frames and/or from the composite frame in one or more of the above mentioned steps of calculating the difference-frames and combing the difference-frames, say by multiplying pixels of one of the received frames by a factor (say by 0.1) and adding the thus multiplied frame to the composite frame, as described in further detail hereinbelow.

Thus, essentially, the composite frame resultant upon the steps described hereinabove, is a single frame that represents the trajectory of the ball as a series of images of the ball as captured in the received video sequence, as if the composite frame is created by overlaying a number of the difference-frames, each frame capturing the ball in a different position within the frame.

Previous methods have relied on resource-expensive object recognition techniques, employed to identify the ball in each video frame, as the ball moves, which as described hereinabove, may prove to be very challenging and resource intensive.

By contrast, with at least some of the exemplary embodiments presented herein, a trajectory of ball as captured in several frames of a video sequence, is extracted into the composite frame—i.e. into a single frame, based on differences calculated among frames of the video sequence. Accordingly, a neuronal network may be trained and employed to locate the trajectory in the composite frame, rather than to locate the ball itself in each and every one of the video sequence's frames.

In one example, the composite frame is added labeling data, say by graphically editing the composite frame on a computer, so as to mark the trajectory in the composite frame. For example, the labeling data may be in a form of a circle added to the composite frame, by encircling an area surrounding the series of images of the ball that represent the ball's trajectory, say using editing software, as described in further detail hereinbelow.

Composite frames may be generated in that way, say prior to the preliminary phase in which the neuronal network is trained (also referred to hereinbelow as the offline stage or offline phase). Alternatively or additionally, composite frames may be generated in that way later, say when employing the trained neuronal network for locating a ball's trajectory and identifying events during a game of sport (i.e. in the stage also referred to hereinbelow as the online stage or online phase).

Thus, in a first example, the composite frame is one of the training frames, and is used to train a neuronal network, as described in further detail hereinbelow.

In a second example, the composite frame is the above described second frame—say a composite frame generated during the game of sport, and is processed by one or more neuronal networks, trained previously using the training frames, so as to locate the trajectory of the ball therein, as described in further detail hereinbelow.

Optionally in the second example, after locating the trajectory, one or more events may be identified based on an analysis of the ball's trajectory located in the second frame, say using the neuronal network that locates the trajectory in the second frame, or rather, by a second neuronal network, as described in further detail hereinbelow.

Prior methods would apply computationally heavy image recognition techniques on each video frame's entire area, so as to find where each ball image appears, and track the changes in the ball's image position from one frame to the other. By contrast, present embodiments rather locate the trajectory first, and then, look for the ball in that limited region of interest, as described in further detail hereinbelow.

Further, present embodiments use frames, each of which frames represents multiple positions of the ball and shows a trajectory (or a significant part thereof) in a single frame, thereby effectively compressing an event of many frames into a single frame. For this reason too, the method of the present invention may prove computationally, much more efficient, as described in further detail hereinbelow.

The principles and operation of a method, apparatus and computer readable memory according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings.

The invention is capable of other embodiments or of being practiced or carried out in various ways. Also, it is to be understood that the phraseology and terminology employed herein is for the purpose of description and should not be regarded as limiting.

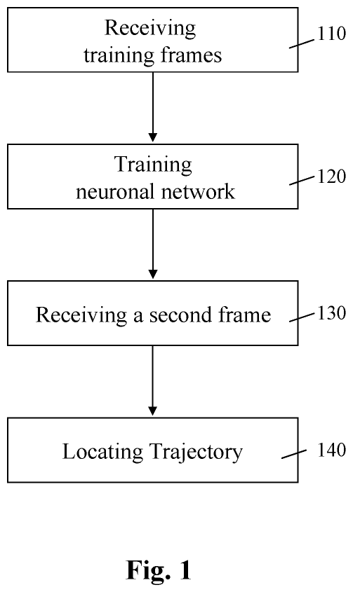

Reference is now made to FIG. 1, which is a simplified flowchart schematically illustrating a first exemplary method of ball trajectory tracking, according to an exemplary embodiment of the present invention.

A first exemplary method of ball trajectory tracking, according to an exemplary embodiment of the present invention, may be executed by a computer—be the computer a single computer, a group of computers in communication over a network, computer circuitry that includes one or more electric circuits, a computer processor and a computer memory, etc., or any combination thereof, as described in further detail hereinbelow.

Thus, in one example, the method is executed by an apparatus that includes a circuit (say an integrated electric circuit (IC)). The circuit of the example includes one or more computer processors, one or more computer memories (say a DRAM (Dynamic Random Access Memory) component, an SSD (Solid State Drive) component, etc.), and one or more other components, etc., as described in further detail hereinbelow.

The computer memory stores instructions, which instructions are executable by the system's computer processor, for performing the steps of the method, as described in further detail hereinbelow.

In the first method, there are received 110 a plurality of training frames, say using the apparatus 14000 described in further detail hereinbelow. Each one of the received 110 training frames shows a trajectory of a ball as a series of one or more elements.

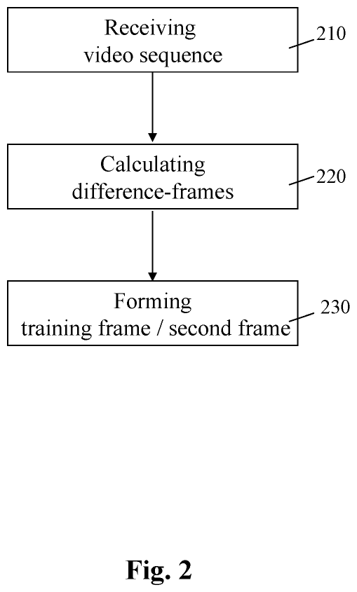

The received 110 training frames may include, for example, one or more composite frames generated in the manner described in further detail hereinbelow and illustrated using FIG. 2.

Additionally or alternatively, the received 110 training frames may include one or more frames (say still or video frames) in which a trajectory of a ball is represented using one or more elements. The elements may include, for example, parts of a dashed line, dots of a dotted line, a solid line, images of a ball, oval graphical objects, graphic symbols, etc., or any combination thereof, as described in further detail hereinbelow.

Optionally, each one of the elements represents a respective position of the ball along the trajectory shown in the frame, as described in further detail hereinbelow.

Next, the received 110 frames are used to train 120 a first neuronal network to locate a trajectory of a ball in a frame.

Optionally, the first neuronal network is trained 120 using the received 110 frames and with labeling data received 110 with each respective one of the training frames, say using the apparatus 14000 described in further detail hereinbelow.

The received 110 labeling data may include, for example, one or more graphical elements that are added to the frame, say using a graphical editor, as known in the art. The graphical element(s) may include, for example, a bounding box or an oval shape added to the frame, so as to mark an area of the frame surrounding the trajectory as shown in the frame, a mark added to each image of a ball that represents a position along the ball's trajectory, etc., as described in further detail hereinbelow.

The received 110 labeling data may additionally or alternatively, include data that list positions (say rows and columns) of the received 110 frame's pixels that make up the trajectory as shown in the frame, data that include the size of the bounding box and the position (i.e. row and column) of the pixel at the center of the bounding box, etc.

Thus, in one example, an expert edits composite frames generated in the manner described in further detail hereinbelow and illustrated using FIG. 2, say using a graphical editor, as known in the art.

In the example, the composite frames are edited by adding a bounding box or another graphical element, to each one of the composite frames, so as to mark an area surrounding the trajectory shown in the specific frame. Thus, in the example, by adding the graphical element, the expert adds the labeling data to the composite frame.

The edited composite frames are then used as the training frames received 110, say by apparatus 14000, as described in further detail hereinbelow.

Optionally, the first neuronal network is a computer implemented ANN (Artificial Neuronal Network) that may be implemented on hardware, software, or a combination of hardware and software, as known the art.

The first neuronal network includes several artificial neurons, also known in the art as units. The units are arranged in a series of layers, as known in the art.

In the example, one of the network's layers is an input layer that includes several input units used to receive pixel values, such that each one of the input units receives pixel values of a respective pixel position—i.e. of a pixel of a specific position within the frame, as described in further detail hereinbelow.

The first neuronal network further includes output units that are used to generate the neuronal network's response to pixel values received by the input units.

In the example, the first neuronal network's response includes output data that indicates the location of a trajectory within the frame having the pixel values received by the input units.

In between the input units and output units are one or more layers of hidden units, which, together, form the majority of the first neuronal network. Connections between one unit and another are represented by a number called a weight, which can be either positive (if one unit excites another) or negative (if one unit suppresses or inhibits another), as known in the art. The higher the weight, the more influence one unit has on the other.

The hidden units encapsulate several computer-executed complex mathematical functions that create predictors, as known in the art. The mathematical functions modify the input data, so as to yield a final set of row predictions (i.e. values) that are input to the output layer. The output layer's units (i.e. the output units) collect the row predictions and produce the neuronal network's results also referred to as the neuronal network's prediction, as known in the art.

With an exemplary embodiment, the neuronal network's prediction consists of data that indicates the location of a trajectory within the frame having the pixel values received by the input units. In one example, the prediction indicates the location using data that defines a position and size of a bounding box or another element that defines an area surrounding the ball's trajectory as shown in the frame, as described in further detail hereinbelow.

Thus, for example, in the training 120 process, the first neuronal network may learn that a trajectory is an elongated, parabola-like object that is comprised of repeated patterns (say multiple images or graphical elements).

Optionally, that trajectory learning is tolerant with respect to the specific shape of the repeated patterns (say ball images) that make up the trajectory as shown in the frame. Thus, the elements that make up the trajectory may be elongated, distorted, blurred, pixelated, fragmented, etc., as long as the elements make up a pattern repeated along a path expected for a trajectory—say a one that resembles a parabola.

The training 120 of the first neuronal network, may be carried out using trajectory learning that is carried out using YOLO, R-CNN (Region-Convolutional Neural Network), Mask R-CNN, Fast R-CNN, Faster R-CNN, SSD Multi-box, a customized learning process, etc., or any combination thereof, as known the art.

In a first example, for training 120 the first neuronal network, when the first neuronal network receives the pixel values of a specific one of the received 110 training frames, some of the input layer's units receive the labeling data received 110 with the specific frame. The labeling data may consist, for example, of one or more graphical elements added to the specific training frame, and is thus input to the neuronal network as pixel values of the pixels that hold the bounding box or other graphical element(s), as described in further detail hereinabove.

Specifically, in the first example, a bounding box or another graphical element used to encircle an area surrounding a trajectory, is of a specific grey level value or of a specific range of grey level values (say a one predefined by a user or operator of the apparatus 14000). Thus, in the example, the labeling data is received by each input unit that happens to receive a grey level value of that specific value or range.

Thus, in the first example, all received 110 training frames are input to the neuronal network, say one frame at a time, such that each specific pixel value of the frame is input to a respective one of the neuronal network's input units, so as to allow the neuronal network to learn the patterns that make up a trajectory of a ball.

In that training 120 process, the neuronal network may optimize the weights of the connections between the hidden units, and other parameters of the neuronal network, as known in the art. The parameters are optimized so as to make the predictions made by the output layer's units (i.e. the location of the ball's trajectory) better fit the area of the trajectory as indicated by the labeling data received for each one of the training frames.

After that training 120, the neuronal network's output layer (i.e. output units) may be able to output data that indicates the location of a trajectory within an input frame having the pixel values received by the input units.

More specifically, in the training 120, after the training frames are input to the neuronal network, the neuronal network adjusts the hidden layer's weights, back propagation learning rule gradient, or other parameters, so as to make the network's predictions better match the received 110 labeling data input to the network. That is to say that, for example, hopefully, the more training frame are input to the neuronal network, the higher the average overlap between the trajectory's area predicted by the network and the trajectory area as indicated by the labeling data, becomes.

The weights and/or other parameters of the network can be adjusted, for example, by solving the optimization problem of minimizing the probability of the detection error on the training data. The optimization problem can be solved, for example, using Stochastic Gradient Descent (SGD), SGD with Momentum, Adagrad, RMSProp, Adam methods, etc., or any combination thereof, as known in the art.

The gradients can be calculated using a backpropagation technique. The activation functions of the convolutional network can be leaky ReLU or activation functions such as Sigmoid, Tan h, Exponential Linear Units (ELU), etc., or any combination thereof, as known in the art

Optionally, a user of the neuronal network is allowed to adjust the weights or other network parameters manually, as known in the art.

Optionally, the received 110 training frames are further used to train 120 a second neuronal network, say an ANN that recognizes images or shapes of a ball along a trajectory located in a frame, using the first neuronal network, as described in further detail hereinbelow.

When training 120 the first neuronal network alone, the optimization problem tries to minimize the misdetection error for the first neuronal network, as known in the art.

However, when training 120 both the first and the second neuronal networks, the optimization problem tries to minimize the over-all misdetection error rather than each network's specific misdetection error. Accordingly, optionally, the back propagation learning rule gradient of the first neuronal network and the back propagation learning rule gradient of the second neuronal network may be made related, as known in the art.

Later, there is received 130 a second frame, say a one captured during a game of sport, say a composite frame generated from a video stream captured during the game of sport, as described in further detail hereinbelow. The second frame shows a trajectory of a ball as a series of images of the ball having the located trajectory, as described in further detail hereinbelow.

Then, the first neuronal network is used to locate 140 the trajectory of the ball in the second frame.

In one example, the received 130 second frame's pixel values are input to the first neuronal network, say by inputting each one of the frame's pixels' grey level value to a respective one of the neuronal network's input units, as described in further detail hereinabove.

Using the weights and hidden units, the neuronal network processes the second frame's pixel values, and the network's output units output data that indicates the location of a ball's trajectory within the second frame, thus locating 140 the trajectory of the ball, as described in further detail hereinabove.

In one example, the data output by the output units indicates the location by giving the coordinates of a pixel at the center of a bounding box that defines a rectangular area surrounding the trajectory and the dimension(s) (i.e. size(s)) of that bounding box, say the smallest box that still contains the trajectory.

In a second example, the output units indicates for each one of the second frame's pixels, whether the pixel is within the area surrounding the ball's trajectory as shown in the second frame. For example, the output units may output a mathematical function that when applied on the pixel's row and column, indicates whether the pixel is within the area surrounding the trajectory as shown, as described in further detail hereinbelow.

Optionally, the method further uses a second neuronal network, as described in further detail hereinabove.

Optionally, the second neuronal network is used to recognize an image of a ball (i.e. recognize that the image is a ball image) along the trajectory located 140 in the second frame, say using known in the art, deep learning object recognition techniques.

Thus, rather than having to look for a ball in the whole second frame (say a frame of 2000×1000 pixels), the second neuronal network has to look for a ball in a much smaller area of interest (say within a rectangular area of 300×150 pixels of an area that the trajectory is located 140 in). As a result, potentially, the second neuronal network may be able to recognize the ball in the second frame more quickly and efficiently.

Optionally, in a preliminary stage, the second neuronal network is similarly trained to recognize a ball, using training frames (say composite frames of the sort described in further detail hereinbelow) that a trajectory is located in each respective one of them. For training the second neuronal network, the second network may accordingly be directed to identify (i.e. recognize) an image of a ball along the located trajectory rather than in the whole training frame, say by inputting values of pixels within the area surrounding the located trajectory only, to the neuronal network.

Optionally, the ball is rather recognized by the first neuronal network, in which case, the first neuronal network is trained 120 and employed for both the locating 140 of the trajectory of a ball, and recognizing ball images along that located 140 trajectory, as described in further detail hereinbelow.

That is to say that with exemplary embodiments, not only may the ball's trajectory be tracked even without applying an object recognition method on each specific video frame that the second frame may be generated from, but even when applied, the techniques are limited to the located 140 trajectory area. That is to say, that with exemplary embodiments, the object recognition is limited to a specific area of interest—namely, to the area of the located 140 trajectory.

Thus, potentially, compared with prior methods, the ball's trajectory tracking may require fewer computational resources, as described in further detail hereinbelow.

Optionally, the first neuronal network, second neuronal network, or both, are further used to identify an event based on the located 140 trajectory, say by weighting together the location of the ball's trajectory, the shape of the ball's trajectory, the balls landing position, etc., as described in further detail hereinbelow.

Optionally, one or more of the training frames, the second frame, or both, are composite frames generated from a video sequence captured by a camera during the sport event, as described in further detail hereinbelow, and as illustrated using FIG. 2.

Thus, in one example, a video sequence captured during a sport event, is used to generate one or more composite frame(s), that when received 130 by the apparatus 14000, are input to the neuronal network trained 120 using previously received 110 composite frames, for locating 140 a ball's trajectory in the received 130 frames.

Reference is now made to FIG. 2, which is a simplified flowchart schematically illustrating a second exemplary method of ball trajectory tracking, according to an exemplary embodiment of the present invention.

A second exemplary method of ball tracking in a sport event, according to an exemplary embodiment of the present invention, may be executed by a computer, say as a part of the first exemplary method, as described in further detail hereinabove.

Thus, in one example, the second method is executed by an apparatus that includes a circuit (say an integrated electric circuit (IC)). The circuit of the example includes one or more computer processors, one or more computer memories (say a DRAM (Dynamic Random Access Memory) component, an SSD (Solid State Drive) component, etc.), and one or more other components, etc., as described in further detail hereinbelow.

The computer memory stores instructions, which instructions are executable by the system's computer processor, for performing the steps of the first method, second method, or both, as described in further detail hereinbelow.

Optionally, for carrying out the second exemplary method, the computer communicates with one or more cameras, say with a video camera, over the internet, over an intranet network, over a local area network, over another network, or any combination thereof, for receiving 210 a video sequence made of video frames captured during a sport event, as described in further detail hereinbelow.

Thus, according to an exemplary embodiment of the present invention, during a sport event that takes place in a constrained environment such as a tennis court or a football field, there is received 210 a video sequence that captures movement of a ball during the sport event in a series of video frames, say by apparatus 14000, as described in further detail hereinbelow.

In one example, the video sequence is captured using a video camera installed in the constrained environment and is streamed live, say over the internet, from the video camera to the apparatus 14000, as described in further detail hereinbelow.

In a second example, the video sequence is captured using a still camera installed in the constrained environment, and is rather made of a series of still frames captured by the still camera during the sport event, which still frames are ordered according to the order in which the still frames are captured.

Then, based on the received 210 video sequence, there are calculated 220 a plurality of difference-frames, say by apparatus 14000, as described in further detail hereinbelow. Each one of the difference-frames is calculated 220 over a respective group of two or more of the video frames of the received 210 video sequence.

In one example, each one of the difference-frames is a grayscale frame calculated 220 over two or more grayscale frames of the received 210 video sequence or over two or more grayscale frames that are the result of a step of converting the received 210 video frames into grayscale format, using known in the art techniques.

A processing of grayscale frames rather than of color frames may potentially improve performance and prevent possible color distortion in composite frames formed 230 using the calculated 220 difference-frames, as described in further detail hereinbelow.

Alternatively, the received 210 video frames are color frames, and the difference-frame is calculated 220 over two or more of the frames, i.e. over color frames.

The difference-frame may be calculated 220, for example, by subtracting between pixel values of the two or more video frames of the respective group of video frames, i.e. between values of pixels that have a same position in the respective video frame, as described in further detail hereinbelow.

The difference-frame may also be calculated 220, by calculating a high order difference over the group's frames (say a difference between differences, or a temporal numerical derivative scheme of higher order), by applying a predefined formula on pixel values of the group's frames, etc., as described in further detail hereinbelow.

Optionally, the calculating 220 further includes changing a resolution of at least one of the video frames of the group, as described in further detail hereinbelow.

For example, one of more of the received 210 video sequence's frame (or a part of the frame) may be decimated—to lower the frame's resolution, over-sampled and interpolated—to increase the frame's resolution, etc., as known in the art.

Optionally, at least a part of the calculating 220 is limited to a region of interest (ROI) in the video frames of the group (say to pixels within a certain region surrounding a tennis court's borderline or a soccer gate, as captured in each one of at least some of the frames), as described in further detail hereinbelow.

The ROI may cover any number of the video frame's pixels—one pixel, twelve pixels, all pixels but certain pixels, all pixels of the frame, etc.

The ROI may actually include two or more ROIs, i.e. be made of two or more separate ROIs selected in the video sequence's frames according to a criterion such as, for example, proximity to a soccer gate (say the two regions surrounding a soccer field's two gates, respectively), basket, borderline on different sides of the court, etc.

Thus, each one of the calculated 220 difference-frames is a video frame that is represents a difference among the respective group's two or more video frames.

Accordingly, each one of the calculated 220 difference-frames is likely to include two or more images of a moving object (particularly, the ball) as captured in the video frames that make up the received 210 video sequence.

The difference-frame is thus meant to include two or more images of ball (one image per each video frame used for calculating 220 the difference-frame, if the ball appears in that video frame of the sequence), as described in further detail hereinbelow.

Each image of the ball that appears in the calculated 220 difference-frame, has a different position within the calculated 220 frame, and represents a different position of the moving ball. However, the difference-frame usually omits at least some of the video sequence's background elements (say court lines, fences, soccer gates, or other elements that do not change or move between the frames of the received 210 video sequence), or a part thereof.

Optionally, for calculating 220 each one of the difference-frames, the video frames are selected for the respective group of frames that the difference-frame is to be calculated 220 over, according to a predefined criterion, say according to a predefined time-dependent criterion, as described in further detail hereinbelow.

Thus, in one example, based on a time-dependent criterion, each specific one of the groups includes the most recently received 210 frame of the video sequence (i.e. the last frame received 210 when the specific difference-frame's calculation 220 over frames of that group starts), and the video sequence's frame received 210 two seconds before that most recently received 210 frame.

In a second example, that is based on a different criterion, the received 210 video sequence or a selected part thereof (say the last ten frames of the received 210 video sequence), is stored in a buffer implemented on a memory of a computer (say a one that is a part of apparatus 14000, as described in further detail hereinbelow).

In the second example, each specific one of the groups that the difference-frames are calculated 220 over, includes one of the frames that is chosen as a central reference frame and all frames within a distance of two frames from that central reference frame, in the received 210 sequence (thus making the group a group of five frames).

Optionally, in the second example, the difference-frames are calculated 220 by deriving a high order difference over the specific group's video frames, as described in further detail hereinabove.

For example, the difference-frame may be calculated 220 by subtracting between each pixel value of the reference frame and values of pixels of each respective one of the frames within the distance, to yield a respective difference for each pixel position (i.e. four differences per each pixel position). Then, a value for each pixel of the difference-frame is calculated 220 by averaging over the four differences that pertain to that pixel's position, or using another calculation made using the differences, as described in further detail hereinbelow.

Further in the method, at least two of the calculated 220 difference-frames are combined 230, so as to form a composite frame that represents a trajectory taken by the ball in the movement as a series of images of the ball as captured in the received 210 video sequence, say by apparatus 14000, as described in further detail hereinbelow.

In one example, for combining 230 the difference-frames, the value of each pixel of the composite frame is set to be the sum of the combined 230 difference-frames' pixel values for the corresponding position within the frame. Thus, for example, the composite frame's pixel positioned second from the left in the third row is set to have a value that is the sum of the values of the difference-frames' pixels, each one of which pixels is positioned second from the left in the third row.

In a second example, for combining 230 the difference-frames, the value of each pixel of the composite frame is set to be the sum of the squares (or other powers—whether complex or a real, as known in the art) of the combined 230 difference-frames' pixel values for the corresponding position within the frame.

In a third example, for combining 230 the difference-frames, the value of each pixel of the composite frame is set using a polynomial or other formula applied on values of the combined 230 difference-frames' pixels of a corresponding position within the frame.

Optionally, the formula includes one or more quasi-static coefficients selected so as to change the timescale of the ball's trajectory, as known in the art.

Optionally, the formula of the third example is predefined by a programmer or operator of apparatus 14000, as described in further detail hereinabove.

Each image of the ball as appearing in the formed 230 composite frame has a different position within the composite frame and represents a different position of the moving ball, as described in further detail hereinbelow.

Optionally, the combining 230 of the difference-frames to form the composite frame, further includes adding at least one of the video frames of the received 210 video sequence to the composite frame, as described in further detail hereinbelow.

As a result, there is added one or more background elements omitted from the difference-frames and/or from the composite frame in one of the above mentioned steps of calculating 220 and combing 230, to the composite frame, as described in further detail hereinbelow.

Optionally, the combining 230 of the difference-frames to form the composite frame, further includes multiplying at least some of the values of the pixels of the at least one of the video frames of the received 210 video sequence by a predefined (say by a programmer of apparatus 14000) factor. The video frame thus multiplied, is then added to the composite frame, for adding at least some of the omitted background elements.

Thus, essentially, the composite frame formed 230 in that combining 230, is a single frame that represents the ball's trajectory as a series of images of the ball as captured in the received 210 video sequence.

Thus, optionally, the manner in which the composite frame is created 230 may resemble an overlaying of all or some of the calculated 220 difference-frames, each of which difference-frames captures the ball in a different position within the difference-frame, to form 230 a single layer that shows an image of the ball in each respective one of the different positions, as described in further detail hereinbelow.

Optionally, a plurality of such composite frames is formed 230 and combined, to form a sequence of video, say a video clip, to illustrate the built-up of the trajectory taken by the ball during the ball's movement as captured in the received 210 video sequence, to emphasize certain moments during the ball's movement, etc.

Each composite frame of the plurality is formed 230 by combining 230 a respective group of at least two of the calculated 220 difference-frames, and represents a trajectory taken by the ball in the movement as a series of images of the ball as captured in the received 210 video sequence.

Optionally, the difference-frames used to form 230 the composite frame are selected according to a predefined criterion, say according to a time-dependent criterion. The criterion may be predefined, for example, by a programmer or operator of apparatus 14000, as described in further detail hereinbelow.

Thus, in one example, according to a first exemplary time-dependent criterion, each group of difference-frames that is used for forming 230 a respective composite frame, includes the most recently calculated 220 one of the difference-frames (i.e. the last difference-frame calculated 220 when the specific composite frame's formation 230 starts). The time-dependent criterion of the example further dictates that the group further include the difference-frames calculated 220 one second before, two seconds before, three seconds before, four second before, and five second before that most recently calculated 220 one of the difference-frames.

In a second example, based on another exemplary time-dependent criterion, each group of calculated 220 difference-frames used for forming 230 a respective composite frame includes the most recently calculated 220 one of the difference-frames (i.e. the last difference-frame calculated 220 when the specific composite frame's generation 230 starts). According to the second example's time-dependent criterion, the group further includes the seven difference-frames calculated 220 immediately before that last difference-frame.

Optionally, when combining 230 the group's difference-frames to form the compound frame, there is given different weight to different ones of the difference-frames that are used for forming 230 the composite frame.

For example, the step of combining 230 may include applying a different weight factor to each one of the difference-frames that are subjected to the combining 230, as described in further detail hereinbelow.

In the example, for forming 230 the composite frame, each difference-frame is given a different weight by multiplying each one of at least some of the difference-frame's pixel values by a weight factor that differs among the difference-frames. The more recent is the difference-frame of the example (and thus, the most recent are the frames that the difference-frame is calculated 220 over), the higher is the weight factor that the difference-frame's pixel values are multiplied by.

In the example, each difference-frames is calculated 220 over a group that includes the most recently received 210 two frames of the video, such that a series of difference-frames is calculated 220 over the received 210 frames of the video sequence, in a sliding window fashion. Whenever a new video frame of the video sequence is received 210, the sliding video is updated in a first-in first-out fashion.

More specifically, in the example, a video sequence made of ten video frames is received 210 in real time or in near real time.

While receiving 210 the frames of the video sequence of the example, one difference-frame is calculated 220 over the most recently received 210 (10^{th}) frame and the frame received 210 immediately before that frame (i.e. the 9^{th} frame). A second difference-frame is calculated 220 earlier, just before that first difference-frame's calculation 220, over the 9^{th} frame and the one received 210 immediately before that 9^{th} frame (i.e. the 8^{th} frame). Earlier in the specific example, one difference-frame is calculated 220 over the 8^{th} frame and the one received 210 immediately before that 8^{th} frame (i.e. the 7^{th} frame), and so forth, thus generating nine difference-frames.

Further in the example, in a sliding window fashion too, each group made of the seven most recently calculated 220 ones of the difference-frames is combined 230, to form 230 a composite frame.

Optionally, as a part of the combining 230, values of pixels of each difference-frame being combined 230, are multiplied by a factor that changes (say exponentially) among the difference-frames, such that the earlier is the difference-frame's calculation 220, the smaller is the factor that the difference-frame's pixel values are multiplied by.

In the example, as a part of that combining 230, the values of the pixels of the most recently (i.e. 7^{th}) calculated 220 one of the seven difference-frames are multiplied by 0.3 and the values of the pixels of the difference-frame calculated 220 immediately before that one (i.e. the 6^{th}) are multiplied by 0.2. Further in the example, the values of the pixels of the remaining five difference-frames (5^{th} to 1^{st}) calculated 220 even earlier, are multiplied by 0.1. The difference-frames of the group are then combined 230, to form 230 the composite frame, by adding their multiplied pixel values of a same position, to set 230 the composite frame's pixel value for that position.

As a result, the trajectory of the ball is still presented in the composite frame as a series of images of the ball as captured in the frames of the video sequence. However, due to the different weight factors given to the difference-frames based on the time of their calculation 220, which time depends on the time of receipt 210 of the most recent one of the frames that the respective difference-frame is calculated 220 over, the trajectory is represented in the composite frame with a “fading out” effect.

Thus, in the example, when the composite frame formed 230 from the difference-frames based on those weight factors, is presented to a user on a screen of a computer or smart phone, the more recent is the position of the ball in the ball's trajectory, the brighter is the image of the ball representing that position to the user (say referee), as described in further detail hereinbelow.

Optionally, the criterion for selecting the calculated 220 difference-frames for the group of difference-frames that are combined 230 to form 230 the composite frame is dynamic, say adaptive, as described in further detail hereinbelow.

Thus, in one example, initially, the criterion dictates that the composite frame is to be formed 230 by combining difference-frames calculated 220 once in every two frames of the received 210 video sequence. However, later on, the criterion is updated (say by an operator of apparatus 14000, or rather automatically—say randomly), so as to dictate that the composite frame is to be formed 230 by combining difference-frames calculated 220 once in every three frames of the received 210 video sequence.

In a second example, initially, the criterion dictates that the composite frame is to be formed 230 by combining difference-frames calculated 220 once in every two seconds. However, later on, the criterion that in the second example, is adaptive, is automatically updated due to changing lighting conditions, so as to dictate that the composite frame is to be formed 230 by combining difference-frames calculated 220 once in every three seconds.

Optionally, in the exemplary method, there are formed 230 two or more composite frames simultaneously, and there may be used a different criterion for selecting the group of difference-frames to be combined 230 to form each respective one of the composite frames.

Thus, in one example, a first composite frame is formed 230 by combining difference-frames, each of which difference-frames is calculated 220 over different two of the received 210 video sequence's frames. Simultaneously to the forming of the first composite sample, a second composite frame is formed 230 by combining difference-frames, each of which difference-frames is calculated 220 over different three of the received 210 video sequence's frames. Optionally, as a result, the ball's trajectory may be represented in two or more composite frames, such that each one of the composite frames represents the ball's trajectory with a different time scale.

In a second example, the simultaneously formed 230 composite frames may additionally or alternatively, differ in the region of interest (ROI). In one case, the first composite frame is formed 230 using difference-frames calculated 220 by subtracting pixel values within a first ROI—say around a first soccer gate, while a second composite frame is formed 230 using difference-frames calculated 220 by subtracting pixel values within a second ROI—say around a second soccer gate.

The ROI may cover any number of the difference frame's pixels—one pixel, twelve pixels, all pixels but certain pixels, etc. The ROI may actually include two or more ROIs, i.e. be made of two or more separate ROIs selected in the difference-frame according to a criterion such as, for example, a criterion pertaining to a specific part of the court, etc.

In a third example, the calculated 220 difference-frames that are combined 230 to form 230 the composite frames do not differ in their ROI.

However, a first composite frame is formed 230 based on a calculation run on a first ROI within the difference-frames combined 230 to form the composite frame, whereas a second composite frame is formed 230 based on a calculation run on a second ROI within the difference-frames combined 230 to form the composite frame.

In a forth example, the composite frame is formed 230 by combining one of the calculated 220 difference frames and using that frame as a central difference-frame (say a one selected by an operator of apparatus 14000), and an equal number (say two) of difference-frames calculated 220 before and after that difference-frame.

Optionally, the second exemplary method further includes a step of presenting the composite frame to a user, for assisting the user in determining occurrence of a predefined event during the sport event, as described in further detail hereinbelow.

Optionally, the composite frame is presented to the user on a screen of a tablet computer or smart phone, for assisting the user (say referee) in determining occurrence of a predefined event (say an “In” or “Out” event) during the sport event, as described in further detail hereinabove.

Indeed, many referees may find such a composite frame that reveals the ball's trajectory using images of the ball as captured in video sequence, to be more convincing than an artificially created image that represents the ball's trajectory that is calculated using other means of tracking a ball.

Optionally, steps 210-230 form a preliminary stage of the first exemplary method, as described in further detail hereinabove. Accordingly, at least some of the composite frames thus formed 230, may make up the training frames that are received 110 and used to train 120 the first neuronal network, as described in further detail hereinabove.

Additionally or alternatively, the steps 210-230 form an intermediate stage of the first exemplary method, and at least one of the composite frames formed 230 in that intermediate step, constitutes the second frame received 130, and used to locate 140 a trajectory of a ball therein, using the first neuronal network, as described in further detail hereinabove.

Whether using the composite frames as training frames—for training 120 the first neuronal network, or as second frames—that the network is used for locating 140 a ball's trajectory in, the network's heavy calculations are run on the composite frames rather than on the frames of the originally received 210 video sequence.

Since each one of the composite frames is formed 230 from multiple difference-frames, and each difference-frame is calculated 220 over multiple frames of the originally received 210 video sequence, the composite frame represents events captured in several video frames in a single frame.

As a result, when compared with the received 210 video frames, the composite frames are much fewer in number, and the computationally heavy calculations that are run on the composite frames need to process much fewer frames, thus saving computer resources in the first method's offline stage 120, online stage 140, or both.

Thus, for example, with the present embodiments, a trajectory of a ball hitting a basket and bouncing back, or bouncing next to a tennis court's border line, may be shown in a single frame, thus potentially, enabling the location 140 of the ball's trajectory throughout the entire In/Out or other event in the single frame, as described in further detail hereinabove.

Further, by contrast to prior methods that would apply computationally heavy image recognition techniques on each video frame's entire area, so as to find where each ball image appears, and track the changes in the ball's image position, present embodiments rather locate the trajectory first, and then, look for the ball in that limited region of interest, as described in further detail hereinabove.

Optionally, the first neuronal network is used for locating 140 ball trajectories using the composite frames, and automatically identifies a predefined event based on the identified trajectories, as apposed to neuronal networks employed merely for identifying the ball itself in the frames (leaving trajectory identifying to computationally heavy subsequent steps), as described in further detail hereinabove.

Alternatively or additionally, the event is rather identified using the second neuronal network, as described in further detail hereinabove.

Optionally, the composite frames may also be used for downsampling the video frames used for 3D analysis, for example, by processing only frame regions of interest (ROI) that correspond to an area within a predefined (say by a programmer of apparatus 14000) distance from the ball's trajectory or specific position.

As a result, for example, a 3D tracking of the ball's movements during an online stage of such 3D analysis, carried out in real time (or near real time) as the ball moves during the sport event, may prove much more efficient in as far as the use of computing resources is concerned.

Optionally, the first exemplary method further includes a step of automatically determining occurrence of a predefined event during the sport event, say according to the ball's trajectory shown in the received 130 second frame (say in one of the composite frames) and located 140 by the first neuronal network.

Thus, for example, the first neuronal network, second neuronal network, or both networks, may be used for automatically determining on which side of the court the ball lands when bouncing, and optionally, for determining an event occurrence.

In one case, in one of the images of the ball shown in the composite frame, the ball is caught in the very moment of landing, thus making the automatic determining of an “In” or “Out” event a potentially straightforward task.

However, in other cases, for determining if the event occurs, the first method may need to interpolate between two images of the ball as captured in the composite frame, based on one or more predefined rules, as described in further detail hereinbelow.

Thus, in one example, the composite frame shows a few images of the ball, and thereby reveals the trajectory taken by the ball, but does not show an image of the ball when actually touching the ground. In the example, an occurrence of an “Out” or “In” event may still be determined automatically, say by interpolating between two images of the ball shown on the ball's located 140 trajectory, to determine whether the ball lands out of the court, as described in further detail hereinbelow.

Using the method steps 210-230 described hereinabove, trajectories of one or more other moving objects such as a player, a tennis racket, etc., may also be represented in the composite frame, say as multiple images of the racket as captured in the video sequence when moving to hit the ball. As a result, for example, a trajectory of the ball may be used together with the trajectory of tennis racket to determine occurrence of a tennis “Topspin” event, say by the first or other neuronal network, when trained to determine such occurrence, as described in further detail hereinabove.

Optionally, the first method further employs other techniques, to determine an occurrence of the predefined event, say gesture recognition techniques applied on player's gestures and actions (say a gatekeeper's jumping or a player's raising her thumb) as captured in the received 210 video sequence, etc., as known in the art.

Optionally, one or more of the steps 210-230 of the exemplary method may further employ one or more other image processing methods, as known in the art. The other image processing methods may include, but are not limited to, for example:
Transformation using synthetic radial distortion, affine or projective transformation, general transformation methods, etc., as known in the art. For example, such transformation may be employed to change the timescale of the ball's trajectory to a one of slower movement (i.e. a slowdown effect), etc., as known in the art.
Color Fitting, say for improving contrast.
Visual Stabilization of video frames.
Contrast Stretching.
De-blurring (say using a point spread function, as known in the art).
Other filters, as known in the art.

Optionally, the composite frame is formed 230 from difference-frames calculated 220 during long periods of the received 210 video sequence and even over all difference-frames calculated 220 over the received 210 video sequence.

In one example, a weight factor of a changing value is used for each difference-frame combined 230 to form the composite frame, say a weight factor decaying exponentially or rather non-exponentially. In the example, the earlier is the calculation 220 of the difference-frame, the smaller is the weight factor that the difference-frame's pixel values are multiplied by during combining 230, as described in further detail hereinabove.

In a second example, the composite frame is formed 230 based on all difference-frame calculated 220 before the composite frame is formed 230, and whenever a new difference-frame is calculated 220 (say when a new video frame is received 210 and used for that calculation 220), the composite frame is updated 230.

In the second example, for forming 230 the updated 230 composite frame, each pixel value of the thus newly formed 230 composite frame is set to a value that is the sum of the product of the previous value of that pixel and a first factor and the product of the new difference-frame's pixel value of a same position within the frame and a second factor. Optionally, the first factor, the second factor, or both factors, are dynamically updated, say by recursively lowering the first factor whenever a new updated 230 composite frame is formed 230, so as to give a gradually decreasing weight to older difference-frames.

Optionally, one or more of the factors and coefficients mentioned hereinabove may be dynamically updated, whether randomly or deterministically, adaptively (say according to a time point of the video sequence, or according to a changing quality of the received 210 frames) or not, etc., as described in further detail hereinabove.

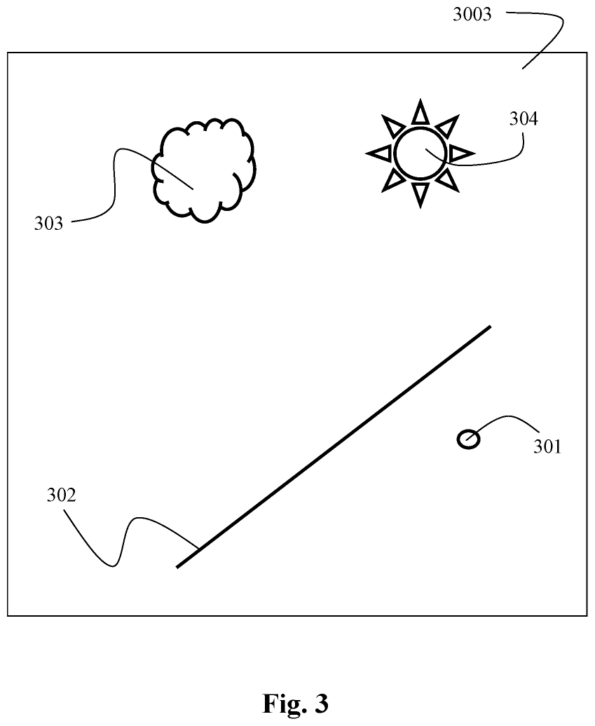

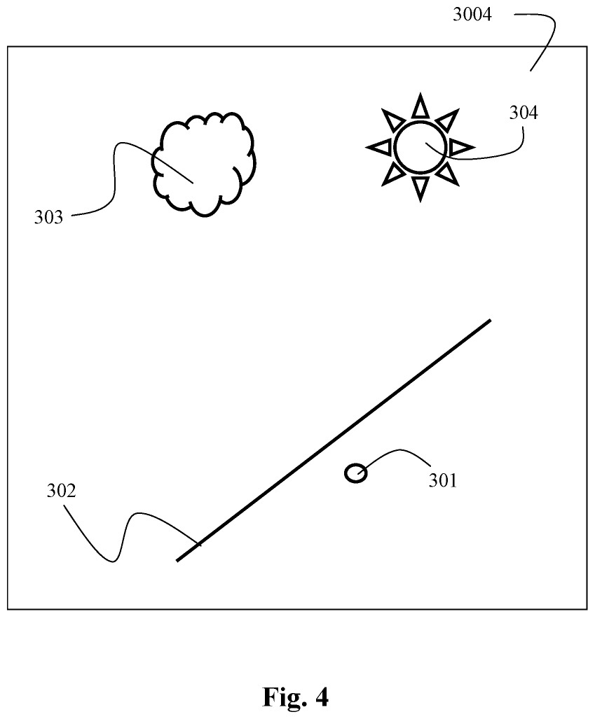

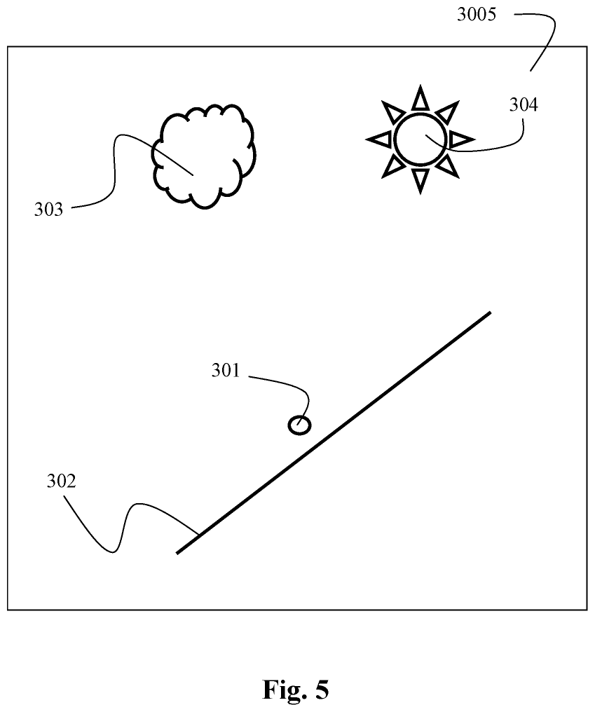

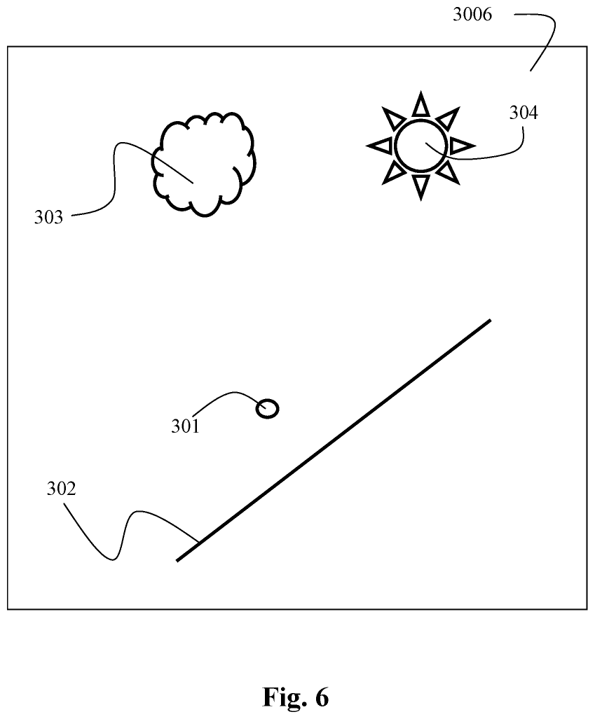

Reference is now made to FIG. 3-10, which are simplified block diagrams schematically illustrating an exemplary implementation scenario of ball trajectory tracking, according to an exemplary embodiment of the present invention.

In one exemplary scenario, during a sport event (say a tennis match), on a partly cloudy day, a video camera installed on a tennis court captures a ball 301 hit by a racket (not shown), as the ball approaches an area surrounding the court's borderline 302.

The video camera captures a video sequence that includes the video frames 3003-3006 illustrated in FIG. 3-6. The frames 3003-3006 capture the moving ball 301, the court borderline 302, and other objects, say a cloud 303 and the sun 304. In each to one of the frames 3003-3006, the ball 301 is captured in a different position.

In the first exemplary scenario, during the receiving of the video sequence, say by apparatus 14000, there is calculated a difference-frame 3007-3008 over each respective pair of frames of the received video sequence received.

In this first exemplary scenario, the difference-frames 3007-3008 are calculated over the first and second frames 3003-3004, and third and fourth frames 3005-3006, respectively.

However, in other exemplary implementation scenarios of exemplary embodiments of the present invention, the video frames for calculating each respective difference-frame over, may be selected differently, as described in further detail hereinabove.

For example, in a second exemplary implementation scenario that implements a sliding window, first in-first out approach, a first difference-frame is calculated over the first and second frames, a second difference-frame is calculated over the second and third frames, etc., as described in further detail hereinabove.

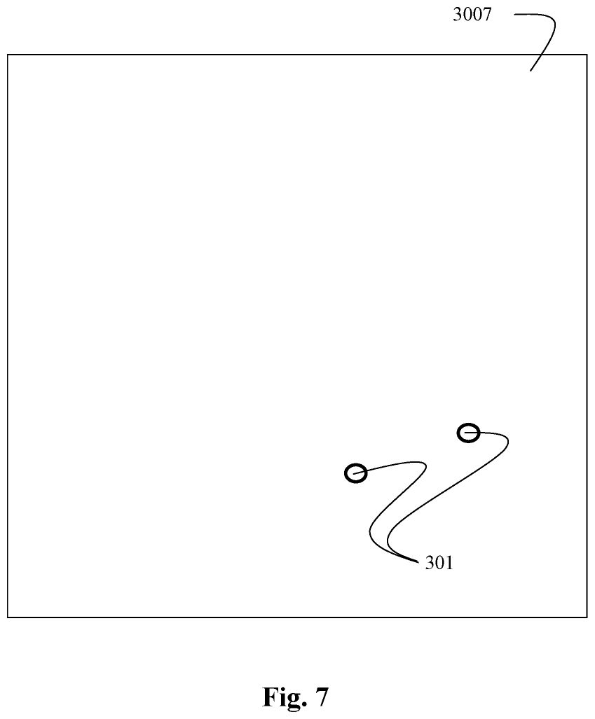

In the first exemplary implementation scenario, when in receipt of the second video frame 3004, there is calculated a first difference-frame 3007, as illustrated in FIG. 7.

In the first scenario, the first difference-frame 3007 is calculated between the first two frames 3003-3004 of the video sequence, say by subtracting between pixel values of a same position within the frames 3003, 3004, as described in further detail hereinabove. Thus, for example, the difference-frame's 3007 second row, first column pixel is set with a value that is the absolute value of the result of subtracting the value of second frame's 3004 pixel positioned in the frame's 3004 second row, first pixel from the value of first frame's 3003 pixel of the frame's 3003 second row, first pixel.

As illustrated in FIG. 7, the first difference-frame 3007 shows the moving ball 301 in two positions, but omits object like the borderline 302, sun 304 and cloud 303 that do not move between the frames 3003-3004 that the first difference-frame 3007 is calculated over.

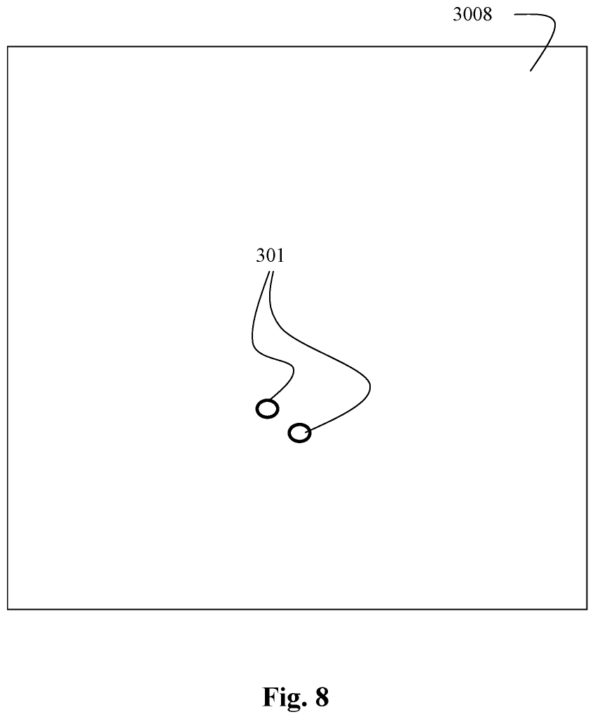

In the first scenario, when in receipt of the fourth video frame 3006, there is similarly calculated a second difference-frame 3008, as illustrated in FIG. 8.

As illustrated in FIG. 8, the second difference-frame 3008 shows the moving ball 301 in two newer positions, but omits the borderline 302, sun 304 and cloud 303 that do not move between the frames 3005-3006 that the second difference-frame 3008 is calculated over, say by subtracting between the frames' 3005-3006 pixel values, as described in further detail hereinabove.

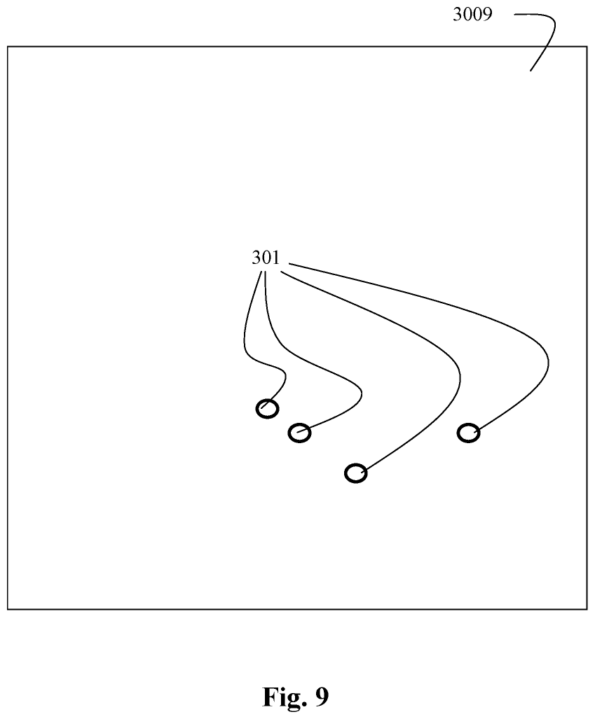

Then, the two difference-frames 3007-3008 are combined, say by apparatus 14000, to form a first composite frame 3009, as illustrated in FIG. 9.

The first composite frame 3009 represents the trajectory taken by the ball 301 during the ball's movement during the sport event, as a series of images of the ball 301, as captured in the frames 3003-3006 of the received video sequence.

Optionally, there is further added one of the frames of the received video—say a one that captures the borderline 302 even before the ball is hit, to form a final composite frame 3010 that shows the borderline 302 too.

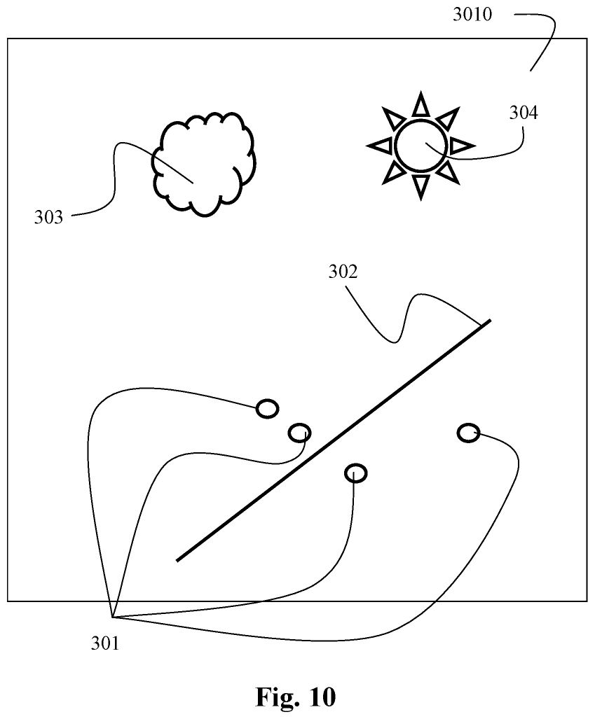

The final composite frame 3010 may be used by the first neuronal network, by the second neuronal network, or by both networks, to determine an occurrence of an event such as a “In” or “Out” event, as illustrated in FIG. 10, and as described in further detail hereinabove.

In the example of the instant scenario, the final composite frame 3010 clearly shows the ball's 301 landing within the borders of court, i.e. to the right of the borderline 302, thus allowing a user (say referee) or one of the neuronal networks, to determine that the event is not an “Out” event.

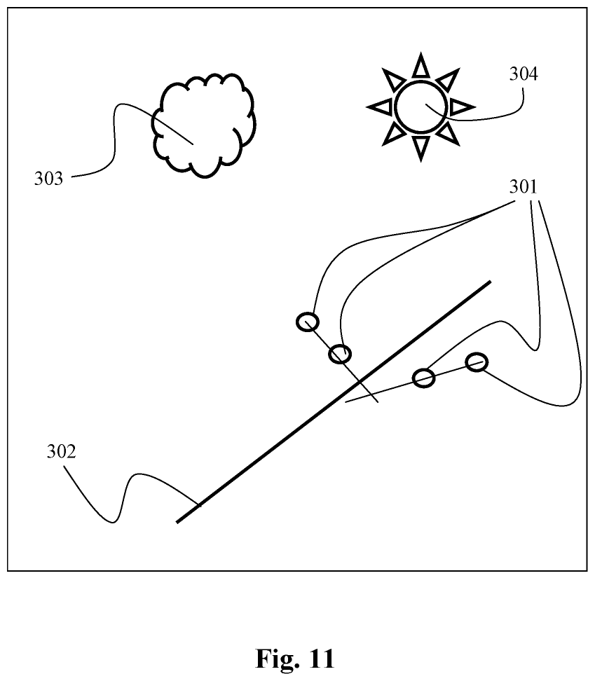

However, in another example, a final composite frame 3011 alone, though showing that the ball bounces, does not show the ball's 301 landing itself, and therefore, does not allow the user (say referee) or the neuronal network, to determine that the event is not an “Out” event, as illustrated in FIG. 11.

However, the ball's 301 trajectory may be interpolated between images of the ball 301 as presented on the composite frame 3011, to determined if the ball 301 lands within the borders of court, i.e. to the right of the borderline 302, as described in further detail hereinabove.

Thus, in one example, according to a rule predefined by a programmer or operator of apparatus 14000, an assumption of linearity near the ball's bouncing position (say by assuming that the ball's 301 velocity does not change the ball's direction significantly during a short time period of say the 0.02 second between frames of a 50 fps video, as known in the art) is employed.

In the example, the landing position of the ball is determined simply by intersecting between two lines, as illustrated in FIG. 11. One line is drawn by connecting the images of the ball 301 that are to the right of the borderline 302, whereas the second line is drawn by connecting the images of the ball 301 that are to the left of the borderline 302.

In the example illustrated using FIG. 11, based on that interpolated landing position, the user (say referee) or the neuronal network determines that the event is not an “Out” event.

Additionally or alternatively to the generation of the composite frames in the manner described in further detail hereinabove, the first exemplary method's training frames, second frame, or both, may be generated in one or more of the following ways, though their generation is not limited to any one or more of the following ways.
Optionally, in each one of the training frames, images of the ball are distributed based on a ball trajectory simulated using different realistic parameters of the ball, of a video recording system, etc.

The parameters may include, but are not limited to: a characteristic of the ball's material (say the material's density, friction coefficient with air, elasticity, etc.), the ball's size, the ball's mass, the ball's initial position, velocity and spin, the forces acting on the ball during flight (say gravity, friction, and bounce), different wind conditions, etc.

The parameter may also include optical parameters such as the ball's color, the ball's texture, the ball's material reflectivity, environmental lightning conditions, camera's intrinsic and extrinsic parameters, radial and tangential lens distortion, a camera's shutter exposure time, an optical system transfer function (spatially dependent point spread function), or frame rate, etc., as known in the art.
Optionally, the training frames (say the composite frames) are generated based on a synthetically generated video of a game of sport, say a video clip featuring a ball, as generated when playing a computer game of sport, say soccer, as known in the art.
Optionally, only the parameters relevant for a specific scenario or type of game, vary among the training frames, say so as to generate the trajectories relevant for the specific scenario or type of game while other parameters are made constant. For example, for certain types of games, the camera parameters, ball size, etc., may be set to be constant.
Optionally, the trajectories are taken from a certain class (bouncing of the ball from a ground, hitting the basket, entering the gate, etc.), so as to train the neuronal network for a specific event type's detection.
Optionally, the training fames may have different backgrounds, be a frame's background the real background of a sport event, a background taken from another moment of the sport event, or a background altered in different ways, so as to train the network in many different realistic background conditions.
Optionally, the background is rather removed from the training frames, leaving the training frames with black background only, so as to train the neuronal network based on trajectories only.
Optionally, the training frames are corrupted by noise (say by corrupting the frames with randomly generated content), so as to train the neuronal network to filter out such noise when trying to locate a trajectory of a ball.
Optionally, one or more of the training frames mimics a change of camera perspective typical of a shaking of the camera during the ball's flight.
Optionally, the training frames are enriched by synthetic data—say by duplicating images of the ball in a manner that interpolates between two images of the ball as shown in one of the composite frames generated in the manner described in further detail hereinabove.
Optionally, elements used to show the trajectory are added different color, so as to help the neuronal network weight the significance (of any) that the color should have when locating the trajectory in a frame.
Optionally, a trajectory shown in a training frame may reflect different wind conditions as felt at different positions along the trajectory, say by deviating from a general parabola-like shape of the trajectory in parts of a trajectory that are supposed to be under wind conditions different from the remaining parts of the trajectory.
Optionally, the frame rate is made irregular.
Optionally, the trajectories shown in the training frames include bouncing.
Optionally, the trajectories shown in the training frames including passes between different players.
Optionally, one or more of the above listed parameters can vary to generate various trajectories to better train the first neuronal network.

The training frame, second frame, or both, can be further normalized prior to inputting their data (say pixel values) to the network, say by zero centering, de-correlation, whitening, etc., or any combination thereof.

The cost function beside the probability of the detection error can have a regularization term such as l1 norm, l2, mixed norm or regularization based on a dropout scheme, as known in the art.

The dropout can also be related to each of neuronal network separately or omitted at parts of the network for both networks, so as to examine on the overall effect.

Optionally, the number of the training frames is artificially increased, say by interpolating between the training frames.

In one example, the training frames are interpolated between, by copying one of the training frames, and then randomly changing the copied training frame's contrast or brightness, or otherwise optically changing the frame, displacing the images or elements that are used to show the ball trajectory, into different positions, adding noise to the frame, etc., or any combination thereof.

Optionally, one or more of the first and second neuronal networks is a pre-trained network such as ImageNet, VGGNet, ResNet, AlexNet, GoogleNet or another neuronal network pre-trained for a similar case. The pre-trained network is then further trained 120 using the training frames, as described in further detail hereinabove.

Optionally, the training 120 of the first neuronal network, of the second neuronal network, or of both, is carried out using a framework such as TensorFlow, Torch, Caffe, etc., or any combination thereof, as known in the art.

The first exemplary method, second exemplary method, or both, may further employ other deep learning methods, say for locating 140 the trajectory within the second frame. The other deep learning methods may include, but are not limited to: Long Short Term Memory (LSTM), BLSTM, variations of these methods, etc., or any combination thereof, as known in the art.

Optionally, the first exemplary method, second exemplary method or both, employ Generative Adversarial network (GAN) schemes, to lower the error probability even further, as known in the art.

Optionally, the first exemplary method, second exemplary method, or both, may prevent over-fitting of the neuronal network to the training frames, say using the a cross-validation method, as known in the art.

In both the first exemplary method and second exemplary method, the training 120, and the locating 140 may be performed on the original, down-sampled (say by dropping some of the frames) or up-sampled (say by interpolating among the training frames or among the second frames) video frames, as described in further detail hereinabove.

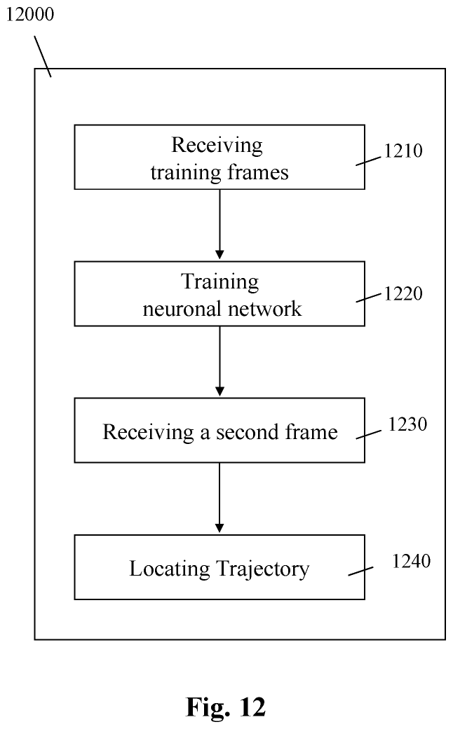

Reference is now made to FIG. 12, which is a simplified block diagram schematically illustrating a first exemplary non-transitory computer readable medium storing computer executable instructions for performing steps of ball trajectory tracking, according to an exemplary embodiment of the present invention.

According to an exemplary embodiment of the present invention, there is provided a first non-transitory computer readable medium 12000.

The medium 12000 may include, but is not limited to, a Micro SD (Secure Digital) Card, a CD-ROM, a USB-Memory, a Hard Disk Drive (HDD), a Solid State Drive (SSD), a computer's ROM chip, a DRAM (Dynamic Random Access Memory) or other RAM (Random Access Memory) component, a cache memory component of a computer processor, etc., or any combination thereof, as known in the art.

The computer readable medium 12000 stores computer executable instructions, for performing steps of ball trajectory tracking, say according to steps of the first exemplary method described in further detail hereinabove, and illustrated using FIG. 1.

The instructions may be executed on one or more computers, say by the computing circuitry of apparatus 14000, as described in further detail hereinbelow.

The computer executable instructions include a step of receiving 1210 a plurality of training frames, say by the apparatus 14000 described in further detail hereinbelow. Each one of the received 1210 training frames shows a trajectory of a ball as a series of one or more elements, as described in further detail hereinabove.

The received 1210 training frames may include, for example, one or more composite frames generated in the manner described in further detail and illustrated using FIG. 2 hereinabove.

Additionally or alternatively, the received 1210 training frames may include one or more frames (say still or video frames) in which a trajectory of a ball (say a to ball hit by a player during a tennis match) is represented using one or more elements. The elements may include, for example, parts of a dashed line, dots of a dotted line, a solid line, images of a ball, oval graphical objects, graphic symbols, etc., or any combination thereof, as described in further detail hereinabove.

Optionally, each one of the elements represents a respective position of the ball along the trajectory shown in the frame, as described in further detail hereinbelow.

The computer executable instructions further include a step of training 1220 a first neuronal network to locate a trajectory of a ball in a frame, the training 1220 being carried out, using the received 1210 frames, as described in further detail hereinabove.

Optionally, the first neuronal network is trained 1220 using the received 1210 frames and labeling data received 1210 with each respective one of the training frames, say using the apparatus 14000, as described in further detail hereinbelow.

The received 1210 labeling data may include, for example, one or more graphical elements that are added to the frame, say using a graphical editor, as known in the art. The graphical element(s) may include, for example, a bounding box or an oval shape added to the frame so as to mark an area of the frame surrounding the trajectory as shown in the frame, a mark added to each image of a ball that represents a position along the ball's trajectory shown in the frame, etc., as described in further detail hereinabove.

The received 1210 labeling may additionally or alternatively, include data that list positions (say rows and columns) of the received 1210 frame's pixels that make up the trajectory shown in the frame, data that include the size of the bounding box and the position (i.e. row and column) of the pixel at the center of the bounding box, etc., as described in further detail hereinabove.

Thus, in one example, an expert edits composite frames generated in the manner described in further detail hereinbelow and illustrated using FIG. 2, by adding a bounding box or another graphical element, to each one of the composite frames, so as to mark an area surrounding the trajectory shown in the specific frame. In the example, by adding the graphical element, the expert adds the labeling data to the composite frame. The composite frame is then used as one of the training frames that are received 1210, say by apparatus 14000, as described in further detail hereinabove.

In one example, the first neuronal network is a computer implemented ANN (Artificial Neuronal Network), as described in further detail hereinabove.

The first neuronal network includes several artificial neurons, also known in the art as units. The units are arranged in a series of layers, as described in further detail hereinabove.

In the example, one of the network's layers is an input layer that includes several input units used to receive pixel values, such that each one of the input units receives pixel values of a respective pixel position—i.e. of a pixel of a specific position within the frame, as described in further detail hereinabove.

The first neuronal network further includes output units that are used to generate the neuronal network's response to pixel values received by the input units, as described in further detail hereinabove.

In the example, the first neuronal network's response includes output data that indicates the location of a trajectory within the frame having the pixel values received by the input units.

In between the input units and output units are one or more layers of hidden units, which, together, form the majority of the first neuronal network. Connections between one unit and another are represented by a number called a weight, which can be either positive (if one unit excites another) or negative (if one unit suppresses or inhibits another), as known in the art. The higher the weight, the more influence one unit has on the other.

The hidden units encapsulate several computer-executed complex mathematical functions that create predictors, as known in the art. The mathematical functions modify the input data, so to yield a final set of row predictions (i.e. values) that are input to the output layer. The output layer's units (i.e. the output units) collect the row predictions and produce the neuronal network's results also referred to as the neuronal network's prediction, as known in the art.

With an exemplary embodiment, the neuronal network's prediction consists of data that indicates the location of a trajectory within the frame having the pixel values received by the input units. In one example, the prediction indicates the location using data that defines a position and size of a bounding box or another element that defines an area surrounding the ball's trajectory as shown in the frame, as described in further detail hereinabove.

In a first example, for training 1220 the first neuronal network, when neuronal network receives the pixel values of a specific one of received 1210 training frames, some of the input layer's units receive the labeling data received 1210 with the specific frame. For example, the labeling data may consist of one or more graphical elements added to the specific training frame, and is thus input to the neuronal network as pixel values of the pixels that hold the bounding box or other graphical element(s), as described in further detail hereinabove.

Specifically, in the first example, a bounding box or another graphical element used to encircle an area surrounding trajectory, is of a specific grey level value or of a specific range of grey level values (say a one predefined by a user or operator of the apparatus 14000). Thus, in the example, the labeling data is received by each input unit that happens to receive a grey level value of that specific value or range.

Thus, in the first example, all received 1210 training frames are input to the neuronal network, say one frame at a time, such that each specific pixel value of the frame is input to a respective one of the neuronal network's input units, so as to allow the neuronal network to learn the patterns that make up a trajectory of ball.

In that training 1220 process, the neuronal may optimize the weights of the connections between the hidden units, the gradient or other network parameters, as described in further detail hereinabove. The parameters are optimized so as to make the predictions made by the output layer's units (i.e. the location of the ball's trajectory) better fit the area of the trajectory as indicated by the labeling data received for each one of the training frames, as described in further detail hereinabove.

After that training 1220, the neuronal network's output layer (i.e. output units) may be able to output data that indicates the location of a trajectory within an input frame having the pixel values received by the input units.

Optionally, after the received 1210 training frames are input to the network and the network automatically adjusts the hidden layer's weights and other parameters accordingly, a user of the network may be allowed to change the weights or other parameters manually, so as to improve the network's predictions, as known in the art.

The computer executable instructions further include a step of receiving 1230 a second frame, say a one captured during a game of sport, say a composite frame generated from a video stream captured during the game of sport, as described in further detail hereinbelow. The second frame shows a trajectory of a ball as a series of images of the ball having the located trajectory, as described in further detail hereinabove.

The computer executable instructions further include a step of using the first neuronal network for locating 1240 the trajectory of the ball in the second frame.

In one example, the received 1230 second frame's pixel values are input to the first neuronal network, say by inputting each one of the frame's pixels' grey level value to a respective one of the neuronal network's input units, as described in further detail hereinabove.

Using the hidden units, the neuronal network processes the second frame's pixel values, and the network's output units output data that indicates the location of a ball's trajectory within the second frame, thus locating 1240 the trajectory of the ball, as described in further detail hereinabove.

In one example, the data output by the output units indicates the location by giving the coordinates of a pixel at the center of a bounding box that defines a rectangular area surrounding the trajectory and the dimension(s) (i.e. size(s)) of that bounding box, say the smallest box that still contains the trajectory.

In a second example, the output units indicates for each one of the second frame's pixels, whether the pixel is within the area surrounding the ball's trajectory as shown in the second frame, as described in further detail hereinabove.

Optionally, the computer executable instructions further use a second neuronal network, as described in further detail hereinabove.

Optionally, the second neuronal network is used to recognize a ball within the second frame's area surrounding the trajectory located 1240 in the second frame, say using known in the art, deep learning object recognition techniques, etc., as described in further detail hereinabove.

Additionally or alternatively, the first neuronal network is used to recognize a ball within the second frame's area surrounding the trajectory located 1240 in the second frame, say using known in the art, deep learning object recognition techniques, etc., as described in further detail hereinabove.

Optionally, the computer executable instructions further use the first neuronal network, second neuronal network, or both, to identify an event based on the located 1240 trajectory, say by weighting together the location of the ball's trajectory, the shape of the ball's trajectory, the balls landing position, etc., as described in further detail hereinabove.

Optionally, one or more of the training frames, the second frame, or both, are composite framed generated from a video sequence captured by a camera during the sport event, as described in further detail hereinbelow, and as illustrated using FIG. 2.

Thus, in one example, a video sequence captured during a sport event, is used to generate one or more composite frame(s), that when received 1230 by the apparatus 14000, are input to the neuronal network trained 1220 using previously received 1210 composite frames, for locating 1240 a ball's trajectory in the received 130 frames, as described in further detail hereinabove.

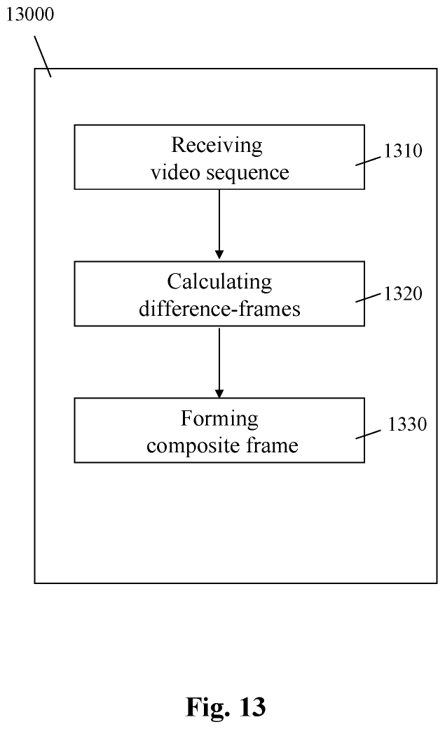

Reference is now made to FIG. 13, which is a simplified block diagram schematically illustrating a second exemplary non-transitory computer readable medium storing computer executable instructions for performing steps of ball trajectory tracking, according to an exemplary embodiment of the present invention.

According to an exemplary embodiment of the present invention, there is provided a second non-transitory computer readable medium 13000.

Optionally, the first 12000 and second 13000 computer readable mediums are separate computer readable mediums, say memories of two computers that are in remote communication over the internet or over another wide area network, as known in the art.

Thus, in one example, a first 13000 one of the mediums is a memory of a first computer used at a location in which a sport event takes place. In the example, a second 12000 one of the mediums is a memory of a second computer in communication with the first computer. The second computer uses one or more neuronal networks, for locating ball trajectories in frames, as described in further detail hereinabove.

Alternatively, the first 12000 and second 13000 computer readable mediums are two memories used by a same computer (i.e. the one that uses the neuronal network), or rather a same single memory, such that the computer executables described hereinbelow and hereinabove, are all stored on that same single memory.

The second medium 13000 may include, but is not limited to, a Micro SD (Secure Digital) Card, a CD-ROM, a USB-Memory, a Hard Disk Drive (HDD), a Solid State Drive (SSD), a computer's ROM chip, a DRAM (Dynamic Random Access Memory) or other RAM (Random Access Memory) component, a cache memory component of a computer processor, etc., or any combination thereof, as known in the art.

The second computer readable medium 13000 stores computer executable instructions, for performing steps of ball trajectory tracking, say according to steps of the second exemplary method described in further detail hereinabove, and illustrated using FIG. 2.

The instructions may be executed on one or more computer, say by the computing circuitry of apparatus 14000, as described in further detail hereinbelow.

Optionally, for executing the instructions, the computer that executes the instructions described hereinbelow, communicates with one or more cameras, say with a video camera. The computer may be integrated into or be physically coupled (say using a wired connection) to the camera itself, communicate with the camera over the internet, over an intranet network, over a local area network, over another network, or any combination thereof, etc., as described in further detail hereinabove.

Thus, the computer executable instructions include a step in which, during a sport event that takes place in a constrained environment such as a tennis court or a football field, there is received 1310 a video sequence that captures movement of a ball during the sport event in a series of video frames, as described in further detail hereinabove.

In one example, the video sequence is captured using a video camera installed in the constrained environment and is streamed live from the video camera to the computer on which the step of receiving 1310 the video sequence is executed, as described in further detail hereinabove.

In a second example, the video sequence is captured using a still camera installed in the constrained environment, and is rather made of a series of still frames captured by the still camera during the sport event, which still frames are received 1310 in the order in which the still frames are captured.

The computer executable instructions further include a step in which, based on received 1310 video sequence, there are calculated 1320 a plurality of difference-frames. Each one of the difference-frames is calculated 1320 over a respective group of two or more of the video frames of the received 1310 video sequence, as described in further detail hereinabove.

The difference-frame may be calculated 1320, for example, by subtracting between pixel values of the two or more video frames of the respective group of video frames, by calculating a high order difference over the group's video frames (say a difference between differences), by applying a predefined formula on pixel values of the group's video frames, etc., as described in further detail hereinabove.

Optionally, the calculating 1320 further includes changing a resolution of at least one of the video frames of the group, as described in further detail hereinabove.

Optionally, at least a part of the calculating 1320 is limited to a region of interest (ROI) in the video frames of the group (say to pixels within a certain region surrounding a tennis court's borderline or a soccer gate, as captured in each one of at least some of the frames), as described in further detail hereinabove.

Thus, each one of the calculated 1320 difference-frames is a video frame that represents a difference among the respective group's two or more video frames, and is accordingly likely to include an image of one or more moving objects (particularly, the ball) as captured in different positions, in the video frames that make up the received 1310 video sequence.

The difference-frame is thus meant to include two or more images of ball (one image per each video frame used for calculating 1320 the difference-frame, if the ball appears in that video frame of the video sequence), as described in further detail hereinabove.

Each image of the ball that appears in the calculated 1320 difference-frame, has a different position within the calculated 1320 frame, and represents a different position of the moving ball. However, the difference-frame usually omits at least some of the video sequence's background elements (say court lines, fences, soccer gates, or other elements that do not change or move between the frames of the received 1310 video sequence), or a part thereof.

Optionally, the executable instructions for calculating 1320 each one of the difference-frames, include selecting the video frames for the respective group of frames that the difference-frame is to be calculated 1320 over, according to a predefined (say time-dependent) criterion, as described in further detail hereinabove.

Thus, in one example, based on a time-dependent criterion, each specific one of the groups includes the most recently received 1310 frame of the video sequence (i.e. the last frame received 1310 when the specific difference-frame's calculation 1320 over frames of that group starts), and the video sequence's frame received 1310 two seconds earlier.

In a second example, that is based on a different criterion, the received 1310 video sequence or a selected part thereof (say the last ten frames of the received 1310 video sequence), is stored in a buffer implemented on a computer memory, as described in further detail hereinabove.

In the second example, each specific one of the groups that the difference-frames are calculated 1320 over, includes one of the frames that is chosen as central reference frame and all frames within a distance of two frames from that central reference frame (thus making the group a group of five frames).

Optionally, in the second example, the difference-frames are calculated 1320 by deriving a high order difference over the specific group's video frames, as described in further detail hereinabove.

In one example, the computer executable instructions calculate 1320 the difference-frame by subtracting between values of pixels of the reference frame and values of pixels of each respective one of the frames within the distance, to yield a respective difference for each pixel position (i.e., to yield four differences).

Optionally, each one of the four differences is used in its absolute value since pixels may bear a positive value only. Then, the instructions calculate 1320 a value for each pixel of the difference-frame, by averaging over the four differences or using another calculation made using the differences, as described in further detail hereinabove.

The computer executable instructions further include a step of combining 1330 at least two of the calculated 1320 difference-frames, as described in further detail hereinabove. In the step 1330, the two or more calculated 1320 difference-frames are combined 1330, to form a composite frame that represents a trajectory taken by the ball in the movement as a series of images of the ball as captured in the received 1310 video sequence, as described in further detail hereinabove.

Each image of the ball as appearing in the composite frame formed in the step of combining 1330, has a different position within the composite frame and represents a different position of the moving ball, as described in further detail hereinabove.

Optionally, the step of combining 1330 the difference-frames to form the composite frame further includes adding at least one of the video frames of the received 1310 video sequence to the composite frame, as described in further detail hereinabove.

As a result, there is added one or more background elements omitted from the difference-frames and/or from the composite frame in one of the above mentioned steps of calculating 1320 and combing 1330, to the composite frame, as described in further detail hereinabove.

Optionally, the step of combining 1330 of the difference-frames to form the composite frame further includes multiplying at least some of the values of the pixels of the at least one of the video frames of the received 1310 video sequence by a predefined factor. The step 1330 further includes adding the video frame thus multiplied, to the composite frame. As a result, at least some of the omitted background elements may be added to the composite frame.

Thus, essentially, the composite frame formed in the step of combining 1330, is a single frame that represents the ball's trajectory as a series of images of the ball as captured in the received 1310 video sequence.

Thus, optionally, the manner in which the composite frame is created 1330 may resemble an overlaying of all or some of the calculated 1320 difference-frames. Each one of the calculated 1320 difference-frames captures the ball in a different position within the difference-frame, and the calculated 1320 difference-frames are thus combined 1330 to form a single layer that shows an image of the ball in each respective one of the different positions, as described in further detail hereinabove.

Optionally, the step of combining 1330 the difference-frames to form the composite frame further includes forming a plurality of such composite frames and combining the composite frames of the plurality, to form a sequence of video, say a video clip. The video sequence formed through that combining of the plurality of composite frames, may serve to illustrate the built-up of the trajectory taken by the ball during the ball's movement as captured in the received 1310 video sequence, to emphasize certain moments during the ball's movement, etc.

Each composite frame of the plurality is formed 1330 by combining 1330 a respective group of at least two of the calculated 1320 difference-frames, and represents a trajectory taken by the ball in the movement as a series of images of the ball as captured in the received 1310 video sequence, as described in further detail hereinabove.

Optionally, further in the step of combining 1330, the difference-frames used to form 1330 the composite frame are selected according to a predefined criterion, say according to a time-dependent criterion. The criterion may be predefined, say by a programmer or operator of apparatus 14000, as described in further detail hereinbelow.

Thus, in one example, according to a first exemplary time-dependent criterion, each group of difference-frames that is used for forming 1330 a respective composite frame, includes the most recently calculated 1320 one of the difference-frames (i.e. the last difference-frame calculated 1320 when the specific composite frame's generation 1330 starts). The time-dependent criterion of the example further dictates that the group further include the difference-frames calculated 1320 one second before, two seconds before, three seconds before, four second before, and five second before that most recently calculated 1320 one of the difference-frames.

In a second example, based on another exemplary time-dependent criterion, each group of difference-frames used for forming 1330 a respective composite frame, includes the most recently calculated 1320 one of the difference-frames (i.e. the last difference-frame calculated 1320 when the specific composite frame's formation 1330 starts). According to the second example's time-dependent criterion, the group further includes the seven difference-frames calculated 1320 immediately before that last difference-frame.

Optionally, in the step of combining 1330 the group's difference-frames to form the compound frame, there is given different weight to different ones of the difference-frames that are used for forming 1330 the composite frame, as described in further detail hereinabove.

For example, the step of combining 1330 may include applying a different weight factor to each one of the difference-frames that are subjected to the combining 1330, as described in further detail hereinabove.

In one example, earlier calculated 1320 ones of the difference-frames are given less weight, as described in further detail hereinabove.

As a result, the trajectory of the ball is still represented in the composite frame as a series of images of the ball as captured in the frames of the received 1310 video sequence. However, due to the different weight factors given to the difference-frames, the trajectory is represented in the composite frame with a “fading out” effect, as described in further detail hereinabove.

In the example, when the composite frame is presented to a user on a screen of a computer (say a one used for adding a bounding box marking a ball's trajectory area to the composite frame), the more recent is the position of the ball in the ball's trajectory, the brighter is the image of the ball representing that position to the user, as described in further detail hereinabove.

Optionally, at least some of the composite frames thus formed 1330, make up the training frames that are received 1210 and used to train 1220 the first neuronal network, as described in further detail hereinabove.

Additionally or alternatively, at least one of the composite frames formed 1330, constitutes the second frame received 1230, and used to locate 1240 a trajectory of a ball therein, using the first neuronal network, as described in further detail hereinabove.

Whether using the composite frames as training frames—for training 1220 the first neuronal network, or as second frames—that the network is used for locating 1240 a ball's trajectory in, the network's heavy calculations are run on the composite frames rather than on the frames of the originally received 1310 video sequence.

Since each one of the composite frames is formed 1330 from multiple difference-frames, and each difference-frame is calculated 1320 over multiple frames of the originally received 1310 video sequence, the composite frame represents events captured in several video frames in a single frame.

As a result, compared with the received 1310 video frames, the composite frames are much fewer in number, and the computationally heavy calculations that are run on the composite frames need to process much fewer frames, thus saving computer resources in the first method's offline stage 120, online stage 140, or both.

Indeed, both the offline stage (i.e. training 120 stage) and the online stage (in which the first neuronal network may need to locate 140 the trajectory), may benefit using the above described methods, as described in further detail hereinabove.

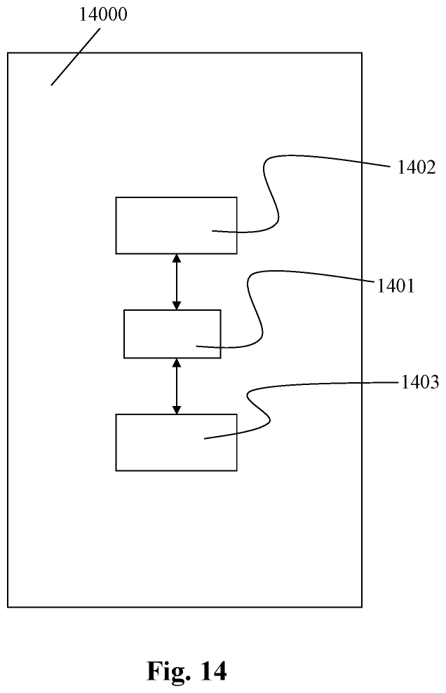

Reference is now made to FIG. 14, which is a simplified block diagram schematically illustrating an exemplary apparatus for ball trajectory tracking, according to an exemplary embodiment of the present invention.

An apparatus 14000 for ball trajectory tracking, according to an exemplary embodiment of the present invention may be implemented using electric circuits, computer software, computer hardware, etc., or any combination thereof.

According to an exemplary embodiment, the apparatus 14000 includes computer circuitry that comprises a computer processor 1401—say a one of a graphical processing unit (GPU) or rather a central processing unit (CPU), and one or more computer memories 1402, say one or more of the computer memories 12000, 13000, as described in further detail hereinabove.

The one or more computer memories 1402 may thus include, but are not limited to: a Hard Disk Drive (HDD), a Solid State Drive (SSD), a computer's ROM chip, a DRAM (Dynamic Random Access Memory) component or another RAM (Random Access Memory) component, a cache memory component of the computer processor 1401, etc., or any combination thereof.

Optionally, the apparatus 14000 further includes a communications card 1403.

The communications card 1403 is used for communicating over a remote (say a communication over the internet), short-ranged (say a communication over a LAN (local Area network) or Wi-Fi Connection), or other connection, say with the cameras, with another computers, etc., as described in further detail hereinabove.

The computer memory stores instructions that are executable by the computer processor 1401, for performing the steps of the first method, second method, or both, as described in further detail and hereinabove and as illustrated using FIG. 1-2, hereinabove.

Thus, in an exemplary embodiment, when executed by the computing circuitry of apparatus 14000, the instructions stored on one or more the computer readable memories 13000, 14000, configure the computing circuitry to perform steps. The performed steps comprise receiving 1210 the training frames, training 1220 the first neuronal network, receiving 1230 the second frame, and using the first neuronal network to locate 1240 the ball, as described in further detail, and as illustrated using FIG. 12 hereinabove.

Optionally, when executed by the computing circuitry, the instructions stored on one or more the computer readable memories 13000, 14000, further configure the computing circuitry to perform the steps of forming the composite frames. The composite frames may be used as the training frames, the second frames, or both, as described in further detail hereinabove.

The performed steps may thus further include receiving 1310 the video sequence, calculating 1320 the difference-frames, and combining 1330 the calculated 1320 difference-frames, to form one or more composite frames that represent ball trajectories, as described in further detail, and as illustrated using FIG. 13 hereinabove.

It is expected that during the life of this patent many relevant devices and systems will be developed and the scope of the terms herein, particularly of the terms “Computer”, “Camera”, “Video”, “Image”, “Frame”, “CD-ROM”, “USB-Memory”, “Hard Disk Drive (HDD)”, “Solid State Drive (SSD)”, Graphical Processing Unit (GPU), Central Processing Unit (CPU), and “Neuronal Network”, is intended to include all such new technologies a priori.

It is also noted that although specific embodiments described hereinabove relate to a ball moving during a sport event, many alternatives, modifications and variations to that specific moving ball embodiments will be apparent to those skilled in the art. Specifically, embodiments in which the methods of the presented embodiments are rather applied to an object that is different from a ball, such as a frisbee, a discus, a tennis racket, or any other object in move during a sport event, are also included herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of ball trajectory tracking, the method comprising computer executable steps of:
receiving a plurality of training frames, each one of the training frames showing a trajectory of a ball as a series of one or more elements;
using the received training frames, training a first neuronal network to locate a trajectory of a ball in a frame;
receiving a second frame; and
using the first neuronal network, locating a trajectory of a ball in the second frame, the trajectory being shown in the second frame as a series of images of the ball having the located trajectory,
the method further comprising computer executable steps of:
receiving a video sequence capturing movement of a ball during a sport event in a series of video frames;
calculating a plurality of difference-frames, each difference-frame being calculated over a respective group of at least two of the video frames of the received video sequence; and
combining at least two of the calculated difference-frames, to form a composite frame representing a trajectory taken by the ball in the movement as a series of images of the ball as captured in the received video sequence, the composite frame being one of the group consisting of the training frames and the second frame.

2. The method of claim 1, wherein at least one of the elements represents a respective position of the ball along the trajectory.

3. The method of claim 1, further comprising receiving labeling data for each respective one of the received training frames, the labeling data indicating a location of the trajectory within the training frame.

4. The method of claim 1, further comprising using a second neuronal network to recognize an image of a ball along the trajectory located using the first neuronal network.

5. The method of claim 1, further comprising using the first neuronal network to recognize an image of a ball along the trajectory located using the first neuronal network.

6. The method of claim 1, further comprising determining occurrence of a predefined event during a sport event, using the trajectory located in the second frame.

7. (canceled)

8. The method of claim 1, wherein said combining further comprises adding at least one of the video frames of the received video sequence to the composite frame.

9. The method of claim 1, wherein said combining further comprises multiplying at least some of the pixels of one of the video frames of the received video sequence by a predefined factor and adding the multiplied video frame to the composite frame.

10. The method of claim 1, further comprising applying a different weight factor to each one of the difference-frames in said combining.

11. The method of claim 1, wherein said calculating is carried out by subtracting between pixel values of the video frames of the group.

12. The method of claim 1, wherein said calculating is carried out by calculating a high order difference over pixel values of the video frames of the group.

13. The method of claim 1, wherein said calculating is carried out by applying a predefined formula on pixel values of the video frames of the group.

14. The method of claim 1, wherein said calculating further comprises changing a resolution of at least one of the video frames of the group.

15. The method of claim 1, wherein said calculating further comprises limiting at least a part of said calculating to a region of interest in the video frames of the group.

16. The method of claim 1, wherein said combining further comprises limiting at least a part of said combining to a region of interest in at least two of the difference-frames.

17. The method of claim 1, further comprising selecting the video frames for each respective one of said groups according to a predefined criterion.

18. The method of claim 1, further comprising selecting the video frames for each respective one of said groups according to a dynamic criterion.

19. The method of claim 1, further comprising selecting the video frames for each respective one of said groups according to a time-dependent criterion.

20. The method of claim 1, further comprising selecting the difference-frames for said combining according to a predefined criterion.

21. The method of claim 1, further comprising selecting the difference-frames for said combining according to a dynamic criterion.

22. The method of claim 1, further comprising selecting the difference-frames for said combining according to a time-dependent criterion.

23. A non-transitory computer readable medium storing computer executable instructions for performing steps of ball trajectory tracking, the steps comprising:
receiving a plurality of training frames, each one of the training frames showing a trajectory of a ball as a series of one or more elements;
using the received training frames, training a first neuronal network to locate a trajectory of a ball in a frame;
receiving a second frame; and
using the first neuronal network, locating a trajectory of a ball in the second frame, the trajectory being shown in the second frame as a series of images of the ball having the located trajectory,
the steps further comprising:
receiving a video sequence capturing movement of a ball during a sport event in a series of video frames;
calculating a plurality of difference-frames, each difference-frame being calculated over a respective group of at least two of the video frames of the received video sequence; and
combining at least two of the calculated difference-frames, to form a composite frame representing a trajectory taken by the ball in the movement as a series of images of the ball as captured in the received video sequence, the composite frame being one of the group consisting of the training frames and the second frame.

24. (canceled)

25. An apparatus for ball trajectory tracking, the apparatus comprising:
computing circuitry; and
a computer memory storing instructions that when executed by the computing circuitry, configure the computing circuitry to perform steps of:
receiving a plurality of training frames, each one of the training frames showing a trajectory of a ball as a series of one or more elements;
using the received training frames, training a first neuronal network to locate a trajectory of a ball in a frame;
receiving a second frame; and
using the first neuronal network, locating a trajectory of a ball in the second frame, the trajectory being shown in the second frame as a series of images of the ball having the located trajectory,
said computer memory further storing instructions for performing steps of:
receiving a video sequence capturing movement of a ball during a sport event in a series of video frames;
calculating a plurality of difference-frames, each difference-frame being calculated over a respective group of at least two of the video frames of the received video sequence; and
combining at least two of the calculated difference-frames, to form a composite frame representing a trajectory taken by the ball in the movement as a series of images of the ball as captured in the received video sequence, the composite frame being one of the group consisting of the training frames and the second frame.

26. (canceled)
